(19) United States
(12) Patent Application Publication
(10) Pub. No.: US 2024/0389142 A1
(43) Pub. Date: Nov. 21, 2024

(54) CHANNEL OCCUPANCY TIME SHARING BETWEEN DOWNLINK AND SIDELINK

(71) Applicant: QUALCOMM Incorporated, San Diego, CA (US)

(72) Inventors: Shaozhen GUO, Beijing (CN); Changlong XU, Beijing (CN); Jing SUN, San Diego, CA (US); Xiaoxia ZHANG, San Diego, CA (US); Aleksandar DAMNJANOVIC, Del Mar, CA (US); Luanxia YANG, Beijing (CN); Siyi CHEN, Beijing (CN); Hao XU, Beijing (CN)

(21) Appl. No.: 18/692,946

(22) PCT Filed: Nov. 15, 2021
(86) PCT No.: PCT/CN2021/130593

§ 371 Date: Mar. 18, 2024

(51) Int. Cl. H04W 74/0808; H04W 92/18

(52) U.S. Cl. CPC H04W 74/0808; H04W 92/18

(57) ABSTRACT

Aspects relate to sharing a channel occupancy time (COT) initiated by a network access node (e.g., a base station) with one or more wireless communication devices for sidelink communication between the wireless communication devices. In this example, the network access node can transmit a COT structure indication (COT-SI) to the wireless communication device(s) indicating the COT resources (e.g., time and frequency resources) of the COT that may be shared with sidelink. In some examples, the wireless communication device can receive a message from the network access node including a COT sharing indicator indicating whether COT sidelink sharing is enabled or disabled.

### TECHNICAL FIELD

The technology discussed below relates generally to wireless communication networks, and more particularly, to mechanisms of sharing a downlink channel occupancy time (COT) with sidelink in unlicensed spectrum.

### INTRODUCTION

The 5G New Radio (NR) mobile telecommunication systems can provide higher data rates, lower latency, and improved system performance than previous generation systems such as Long Term Evolution (LTE) communication systems. To meet the increasing demand in wireless communications, additional spectrum is needed. However, the amount of licensed spectrum is limited. Therefore, using unlicensed or shared spectrum offers a solution to meet the exponential increase in wireless communication demand. When using an unlicensed carrier, a wireless communication device or a network access node (e.g., a base station) may initiate a channel occupancy time (COT) and utilize a channel access procedure to sense and access the channel prior to any transmission.

Unlicensed spectrum may be utilized for both cellular communications and for sidelink communications. For cellular communications, a cellular network may enable user equipment (UEs) to communicate with one another through signaling with a nearby base station or cell. For sidelink communications, UEs may signal one another directly, rather than via an intermediary base station or cell. In some sidelink network configurations, UEs may further communicate in a cellular network, generally under the control of a base station. Thus, the UEs may be configured for uplink and downlink signaling via a base station and further for sidelink signaling directly between the UEs without transmissions passing through the base station.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, a wireless communication device configured for wireless communication is disclosed. The wireless communication device includes a transceiver, a memory, and a processor coupled to the transceiver and the memory. The processor and the memory are configured to receive a channel occupancy time (COT) structure indication via the transceiver from a network access node for a COT initiated by the network access node on an unlicensed carrier. The COT structure indication indicating COT resources shared between downlink communication and sidelink communication. The processor and the memory are further configured to perform a channel access procedure for a sidelink transmission within the COT resources.

Another example provides a method for wireless communication at a wireless communication device. The method includes receiving a channel occupancy time (COT) structure indication from a network access node for a COT initiated by the network access node on an unlicensed carrier. The COT structure indication indicating COT resources shared between downlink communication and sidelink communication. The method further includes performing a channel access procedure for a sidelink transmission within the COT resources.

Another example provides a network access node configured for wireless communication. The network access node includes a transceiver, a memory, and a processor coupled to the transceiver and the memory. The processor and the memory are configured to transmit a message to at least one wireless communication device via the transceiver. The message including a channel occupancy time (COT) sharing indicator indicating that COT sidelink sharing is enabled or disabled. The processor and the memory are further configured to transmit a COT structure indication via the transceiver to the at least one wireless communication device for a COT initiated by the network access node on an unlicensed carrier. The COT structure indication indicating COT resources shared between downlink communication and sidelink communication based on the COT sharing indicator indicating that the COT sidelink sharing is enabled.

Another example provides a method for wireless communication at a network access node. The method includes transmitting a message to at least one wireless communication device. The message includes a channel occupancy time (COT) sharing indicator indicating that COT sidelink sharing is enabled or disabled. The method further includes transmitting a COT structure indication to the at least one wireless communication device for a COT initiated by the network access node on an unlicensed carrier. The COT structure indication indicating COT resources shared between downlink communication and sidelink communication based on the COT sharing indicator indicating that the COT sidelink sharing is enabled.

These and other aspects will become more fully understood upon a review of the detailed description, which follows. Other aspects, features, and examples will become apparent to those of ordinary skill in the art, upon reviewing the following description of specific, exemplary examples of in conjunction with the accompanying figures. While features may be discussed relative to certain examples and figures below, all examples can include one or more of the advantageous features discussed herein. In other words, while one or more examples may be discussed as having certain advantageous features, one or more of such features may also be used in accordance with the various examples discussed herein. In similar fashion, while exemplary examples may be discussed below as device, system, or method examples such exemplary examples can be implemented in various devices, systems, and methods.

### BRIEF DESCRIPTION OF THE DRAWINGS

FIG. 1 is a diagram illustrating an example of a wireless radio access network according to some aspects.

FIG. 2 is a diagram illustrating an example of a frame structure for use in a wireless communication network according to some aspects.

FIG. 3 is a diagram illustrating an example of a wireless communication network employing sidelink communication according to some aspects.

FIG. 4 is a schematic illustration of a first type of channel access procedure according to some aspects of the disclosure.

FIG. 5 is a table illustrating different channel access priority classes and associated parameters according to some aspects of the disclosure.

FIGS. 6A and 6B are schematic illustration of second types of channel access procedure according to some aspects of the disclosure.

FIG. 7 is a diagram illustrating an exemplary channel access procedure using a channel occupancy time (COT) initiated by a scheduling entity according to some aspects of the disclosure.

FIGS. 8A and 8B are diagrams illustrating an example of COT sidelink sharing according to some aspects.

FIG. 9 is a diagram illustrating an example of COT sharing between downlink, uplink, and sidelink according to some aspects.

FIGS. 10A-10D are diagrams illustrating examples of CP extension, LBT type, and CAPC for COT sidelink sharing according to some aspects.

FIG. 11 is a flow chart illustrating an exemplary process for determining an ED threshold for COT sidelink sharing according to some aspects.

FIG. 12 is a flow chart illustrating an exemplary process for determining a default ED threshold for COT sidelink sharing according to some aspects.

FIG. 13 is a table illustrating an example of sidelink ED thresholds for COT sidelink sharing according to some aspects.

FIG. 14 is a table illustrating another example of sidelink ED thresholds for COT sidelink sharing according to some aspects.

FIG. 15 is a block diagram illustrating an example of a hardware implementation for a wireless communication device employing a processing system according to some aspects.

FIG. 16 is a flow chart of an exemplary method for COT sharing between downlink and sidelink according to some aspects.

FIG. 17 is a block diagram illustrating an example of a hardware implementation for a network access node employing a processing system according to some aspects

FIG. 18 is a flow chart of an exemplary method for facilitating COT sharing between downlink and sidelink according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station or UE), end-user devices, etc. of varying sizes, shapes and constitution.

When using an unlicensed carrier (e.g., New Radio—Unlicensed (NR-U)), a wireless communication device (e.g., a scheduled entity, a user equipment (UE), etc.) or a network access node (e.g., a scheduling entity, a base station, a gNode B (gNB), etc.) may initiate a channel occupancy time (COT) of a channel of the unlicensed carrier. The COT is associated with a COT duration in the time domain and available listen-before-talk (LBT) bandwidths in the frequency domain. Upon initiating the COT, the wireless communication device or the network access node can use a channel access procedure to sense the channel using, for example, energy detection. After performing the channel access procedure, the wireless communication device or network access node can access the channel for an upcoming transmission (e.g., uplink or downlink transmission) in the COT.

In an aspect, the network access node can share a COT initiated by the network access node with one or more wireless communication devices for sidelink communication between the wireless communication devices. In this example, the network access node can transmit a COT structure indication (COT-SI) to the wireless communication device(s) indicating the COT resources (e.g., time and frequency resources) of the COT that may be shared with sidelink. The COT-SI may be transmitted, for example, within downlink control information (DCI), such as DCI format 2_0. For example, the COT-SI may include a frequency bitmap to indicate the available LBT bandwidths in the frequency domain and a COT duration bit field per serving cell that indicates a remaining length (duration) from the beginning of a slot within which the DCI format 2_0 containing the COT-SI is received.

In some examples, COT sidelink sharing may be enabled or disabled in various manners. In one example, COT sidelink sharing may be pre-configured on the wireless communication device (e.g., by the original equipment manufacturer (OEM) based on one or more standards or specifications). In this example, the wireless communication device can share a network-initiated COT upon detecting the DCI 2_0 including the COT-SI. In another example, COT sidelink sharing may be semi-statically or dynamically enabled or disabled. For example, the wireless communication device can receive a message from the network access node including a COT sharing indicator indicating whether COT sidelink sharing is enabled or disabled. In response to the COT sharing indicator indicating that COT sidelink sharing is enabled, the wireless communication device can then share the network-initiated COT upon detecting the DCI 2_0 including the COT-SI. In some examples, the message may include a radio resource control (RRC) message and the COT sharing indicator may include an RRC parameter. In other examples, the message may include the DCI 2_0 and the COT sharing indicator may include a bit value (e.g., set to 1 for enabled and 0 for disabled).

In examples in which COT sidelink sharing is enabled, the wireless communication device may perform a channel access procedure for a sidelink transmission based on the COT-SI. For example, the wireless communication device may determine the duration in the time domain and the location in the frequency domain of a remaining COT initiated by the network access node. The wireless communication device may then select between a first channel access procedure type (e.g., a Type 1 channel access procedure) normally utilized in resources outside of the COT to gain access to a channel for the sidelink transmission and a second channel access procedure type (e.g., a Type 2A channel access procedure) utilized within the COT resources of the remaining COT to gain access to a channel for the sidelink transmission. A Type 1 channel access procedure may utilize, for example, Cat 4 LBT in which a random back-off based on a variable-sized contention window is utilized to access the channel. A Type 2A channel access procedure may utilize, for example, Cat 2 LBT in which a fixed CCA period (e.g., 25 microseconds) is utilized to access the channel. Thus, by using a Type 2A channel access procedure with COT sidelink sharing instead of a Type 1 channel access procedure, the latency of sidelink transmissions may be reduced. In addition, using a Type 2A channel access procedure with COT sidelink sharing instead of a Type 1 channel access procedure may further reduce the processing and extend the battery life of wireless communication devices. Furthermore, COT sidelink sharing may maximize resource usage within the COT and increase available resources outside of the COT.

In some examples, the LBT type (e.g., Cat 2 LBT) along with other parameters, including a cyclic prefix (CP) extension length and a channel access priority class (CAPC), for COT sidelink sharing may be indicated via a new channel access cyclic prefix (CP) extension channel access priority class (ChannelAccess-CPext-CAPC) field. The new ChannelAccess-CPext-CAPC field may be transmitted within DCI format 3_0, which further carries sidelink resource information. In some examples, the allowed combinations of the LBT type, CP extension length, and CAPC may be configured via RRC signaling and the DCI 3_0 may indicate one of the allowed combinations to utilize for COT sidelink sharing. In some examples, new CP extension lengths may be supported for COT sidelink sharing.

In some examples, the wireless communication device may utilize an energy detection (ED) threshold during LBT to determine whether the channel is idle or busy. For example, the wireless communication device may compare the measured energy level of signals transmitted by other devices on the channel to the ED threshold. The wireless communication device may then access the channel in response to the measured energy level being less than the ED threshold. For COT sidelink sharing, the wireless communication device may either reuse the same ED threshold as COT uplink sharing or may support a separate ED threshold configuration.

In some examples, the wireless communication device may be RRC configured with a new sidelink ED threshold (e.g., maxEnergyDetectionThreshold-SL) and/or an ED threshold offset (e.g., energyDetectionThresholdOffset-SL) that may be used adjust a default ED threshold according to the offset value indicated by the ED threshold offset. For example, the default ED threshold may be determined based on either a single channel LBT bandwidth or a maximum ED threshold defined for the unlicensed carrier by a regulatory requirement. As another example, the default ED threshold may be determined based on the single channel LBT bandwidth and a maximum configured transmit power in sidelink for the wireless communication device.

In other examples, the ED threshold may be configured based on the occupied bandwidth and the maximum configured transmit power in sidelink for the wireless communication device. For example, the wireless communication device may be RRC configured with a table populated with ED threshold values based on the occupied bandwidth and the maximum configured transmit power. In some other example, the wireless communication device may determine the ED threshold based on a predefined formula which is a function of the occupied bandwidth and the maximum configured transmit power.

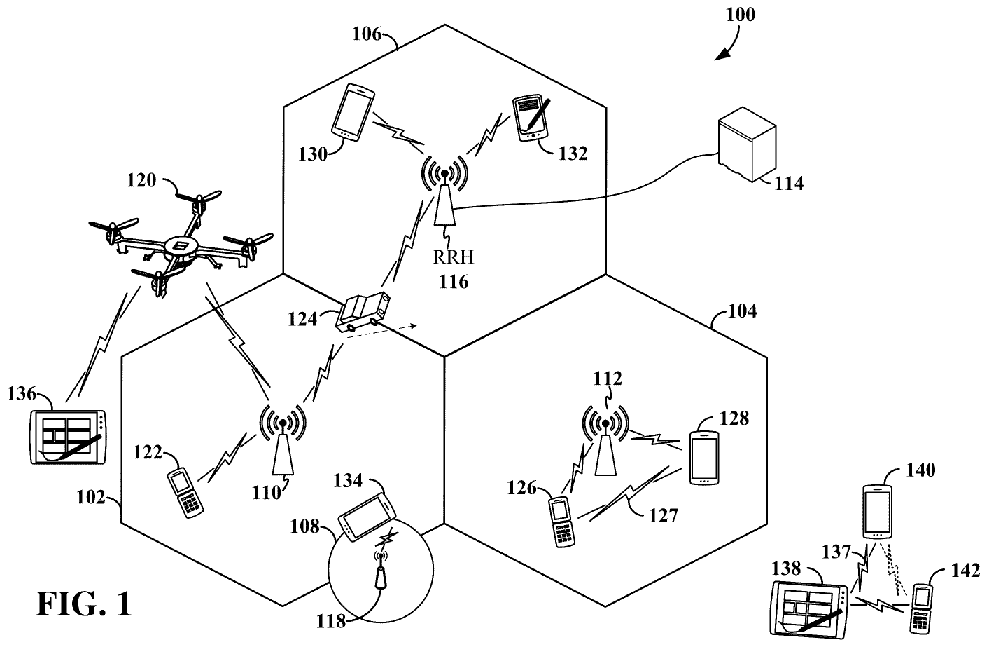

The various concepts presented throughout this disclosure may be implemented across a broad variety of telecommunication systems, network architectures, and communication standards. Referring now to FIG. 1, as an illustrative example without limitation, a schematic illustration of a radio access network 100 is provided. The RAN 100 may implement any suitable wireless communication technology or technologies to provide radio access. As one example, the RAN 100 may operate according to 3^{rd} Generation Partnership Project (3GPP) New Radio (NR) specifications, often referred to as 5G. As another example, the RAN 100 may operate under a hybrid of 5G NR and Evolved Universal Terrestrial Radio Access Network (cUTRAN) standards, often referred to as LTE. The 3GPP refers to this hybrid RAN as a next-generation RAN, or NG-RAN. Of course, many other examples may be utilized within the scope of the present disclosure.

The geographic region covered by the radio access network 100 may be divided into a number of cellular regions (cells) that can be uniquely identified by a user equipment (UE) based on an identification broadcasted over a geographical area from one access point or base station. FIG. 1 illustrates cells 102, 104, 106, and cell 108, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

In general, a respective base station (BS) serves each cell. Broadly, a base station is a network element in a radio access network responsible for radio transmission and reception in one or more cells to or from a UE. A BS may also be referred to by those skilled in the art as a base transceiver station (BTS), a radio base station, a radio transceiver, a transceiver function, a basic service set (BSS), an extended service set (ESS), an access point (AP), a Node B (NB), an eNode B (CNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band. In examples where the RAN 100 operates according to both the LTE and 5G NR standards, one of the base stations may be an LTE base station, while another base station may be a 5G NR base station.

Various base station arrangements can be utilized. For example, in FIG. 1, two base stations 110 and 112 are shown in cells 102 and 104; and a third base station 114 is shown controlling a remote radio head (RRH) 116 in cell 106. That is, a base station can have an integrated antenna or can be connected to an antenna or RRH by feeder cables. In the illustrated example, the cells 102, 104, and 106 may be referred to as macrocells, as the base stations 110, 112, and 114 support cells having a large size. Further, a base station 118 is shown in the cell 108 which may overlap with one or more macrocells. In this example, the cell 108 may be referred to as a small cell (e.g., a microcell, picocell, femtocell, home base station, home Node B, home eNode B, etc.), as the base station 118 supports a cell having a relatively small size. Cell sizing can be done according to system design as well as component constraints.

It is to be understood that the radio access network 100 may include any number of wireless base stations and cells. Further, a relay node may be deployed to extend the size or coverage area of a given cell. The base stations 110, 112, 114, 118 provide wireless access points to a core network for any number of mobile apparatuses.

FIG. 1 further includes an unmanned aerial vehicle (UAV) 120, which may be a drone or quadcopter. The UAV 120 may be configured to function as a base station, or more specifically as a mobile base station. That is, in some examples, a cell may not necessarily be stationary, and the geographic area of the cell may move according to the location of a mobile base station such as the UAV 120.

In general, base stations may include a backhaul interface for communication with a backhaul portion (not shown) of the network. The backhaul may provide a link between a base station and a core network (not shown), and in some examples, the backhaul may provide interconnection between the respective base stations. The core network may be a part of a wireless communication system and may be independent of the radio access technology used in the radio access network. Various types of backhaul interfaces may be employed, such as a direct physical connection, a virtual network, or the like using any suitable transport network.

The RAN 100 is illustrated supporting wireless communication for multiple mobile apparatuses. A mobile apparatus is commonly referred to as user equipment (UE) in standards and specifications promulgated by the 3rd Generation Partnership Project (3GPP), but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides a user with access to network services.

Within the present document, a “mobile” apparatus need not necessarily have a capability to move, and may be stationary. The term mobile apparatus or mobile device broadly refers to a diverse array of devices and technologies. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a mobile apparatus may provide for connected medicine or telemedicine support, i.e., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Within the RAN 100, the cells may include UEs that may be in communication with one or more sectors of each cell. For example, UEs 122 and 124 may be in communication with base station 110; UEs 126 and 128 may be in communication with base station 112; UEs 130 and 132 may be in communication with base station 114 by way of RRH 116; UE 134 may be in communication with base station 118; and UE 136 may be in communication with mobile base station 120. Here, each base station 110, 112, 114, 118, and 120 may be configured to provide an access point to a core network (not shown) for all the UEs in the respective cells. In some examples, the UAV 120 (e.g., the quadcopter) can be a mobile network node and may be configured to function as a UE. For example, the UAV 120 may operate within cell 102 by communicating with base station 110.

Wireless communication between a RAN 100 and a UE (e.g., UE 122 or 124) may be described as utilizing an air interface. Transmissions over the air interface from a base station (e.g., base station 110) to one or more UEs (e.g., UE 122 and 124) may be referred to as downlink (DL) transmission. In accordance with certain aspects of the present disclosure, the term downlink may refer to a point-to-multipoint transmission originating at a scheduling entity (described further below; e.g., base station 110). Another way to describe this scheme may be to use the term broadcast channel multiplexing. Transmissions from a UE (e.g., UE 122) to a base station (e.g., base station 110) may be referred to as uplink (UL) transmissions. In accordance with further aspects of the present disclosure, the term uplink may refer to a point-to-point transmission originating at a scheduled entity (described further below; e.g., UE 122).

For example, DL transmissions may include unicast or broadcast transmissions of control information and/or traffic information (e.g., user data traffic) from a base station (e.g., base station 110) to one or more UEs (e.g., UEs 122 and 124), while UL transmissions may include transmissions of control information and/or traffic information originating at a UE (e.g., UE 122). In addition, the uplink and/or downlink control information and/or traffic information may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In some examples, access to the air interface may be scheduled, wherein a scheduling entity (e.g., a base station) allocates resources (e.g., time-frequency resources) for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs or scheduled entities utilize resources allocated by the scheduling entity.

Base stations are not the only entities that may function as a scheduling entity. That is, in some examples, a UE may function as a scheduling entity, scheduling resources for one or more scheduled entities (e.g., one or more other UEs). For example, two or more UEs (e.g., UEs 138, 140, and 142) may communicate with each other using sidelink signals 137 without relaying that communication through a base station. In some examples, the UEs 138, 140, and 142 may each function as a scheduling entity or transmitting sidelink device and/or a scheduled entity or a receiving sidelink device to schedule resources and communicate sidelink signals 137 therebetween without relying on scheduling or control information from a base station. In other examples, two or more UEs (e.g., UEs 126 and 128) within the coverage area of a base station (e.g., base station 112) may also communicate sidelink signals 127 over a direct link (sidelink) without conveying that communication through the base station 112. In this example, the base station 112 may allocate resources to the UEs 126 and 128 for the sidelink communication. In either case, such sidelink signaling 127 and 137 may be implemented in a peer-to-peer (P2P) network, a device-to-device (D2D) network, a vehicle-to-vehicle (V2V) network, a vehicle-to-everything (V2X) network, a mesh network, or other suitable direct link network.

In some examples, a D2D relay framework may be included within a cellular network to facilitate relaying of communication to/from the base station 112 via D2D links (e.g., sidelinks 127 or 137). For example, one or more UEs (e.g., UE 128) within the coverage area of the base station 112 may operate as relaying UEs to extend the coverage of the base station 112, improve the transmission reliability to one or more UEs (e.g., UE 126), and/or to allow the base station to recover from a failed UE link due to, for example, blockage or fading.

Two primary technologies that may be used by V2X networks include dedicated short range communication (DSRC) based on IEEE 802.11p standards and cellular V2X based on LTE and/or 5G (New Radio) standards. Various aspects of the present disclosure may relate to New Radio (NR) cellular V2X networks, referred to herein as V2X networks, for simplicity. However, it should be understood that the concepts disclosed herein may not be limited to a particular V2X standard or may be directed to sidelink networks other than V2X networks.

In order for transmissions over the air interface to obtain a low block error rate (BLER) while still achieving very high data rates, channel coding may be used. That is, wireless communication may generally utilize a suitable error correcting block code. In a typical block code, an information message or sequence is split up into code blocks (CBs), and an encoder (e.g., a CODEC) at the transmitting device then mathematically adds redundancy to the information message. Exploitation of this redundancy in the encoded information message can improve the reliability of the message, enabling correction for any bit errors that may occur due to the noise.

Data coding may be implemented in multiple manners. In early 5G NR specifications, user data is coded using quasi-cyclic low-density parity check (LDPC) with two different base graphs: one base graph is used for large code blocks and/or high code rates, while the other base graph is used otherwise. Control information and the physical broadcast channel (PBCH) are coded using Polar coding, based on nested sequences. For these channels, puncturing, shortening, and repetition are used for rate matching.

Aspects of the present disclosure may be implemented utilizing any suitable channel code. Various implementations of base stations and UEs may include suitable hardware and capabilities (e.g., an encoder, a decoder, and/or a CODEC) to utilize one or more of these channel codes for wireless communication.

In the RAN 100, the ability for a UE to communicate while moving, independent of their location, is referred to as mobility. The various physical channels between the UE and the RAN are generally set up, maintained, and released under the control of an access and mobility management function (AMF). In some scenarios, the AMF may include a security context management function (SCMF) and a security anchor function (SEAF) that performs authentication. The SCMF can manage, in whole or in part, the security context for both the control plane and the user plane functionality.

In some examples, a RAN 100 may enable mobility and handovers (i.e., the transfer of a UE's connection from one radio channel to another). For example, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 124 may move from the geographic area corresponding to its serving cell 102 to the geographic area corresponding to a neighbor cell 106. When the signal strength or quality from the neighbor cell 106 exceeds that of its serving cell 102 for a given amount of time, the UE 124 may transmit a reporting message to its serving base station 110 indicating this condition. In response, the UE 124 may receive a handover command, and the UE may undergo a handover to the cell 106.

In various implementations, the air interface in the RAN 100 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

The air interface in the RAN 100 may utilize one or more multiplexing and multiple access algorithms to enable simultaneous communication of the various devices. For example, 5G NR specifications provide multiple access for UL or reverse link transmissions from UEs 122 and 124 to base station 110, and for multiplexing DL or forward link transmissions from the base station 110 to UEs 122 and 124 utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 110 to UEs 122 and 124 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Further, the air interface in the RAN 100 may utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full duplex (SBFD), also known as flexible duplex.

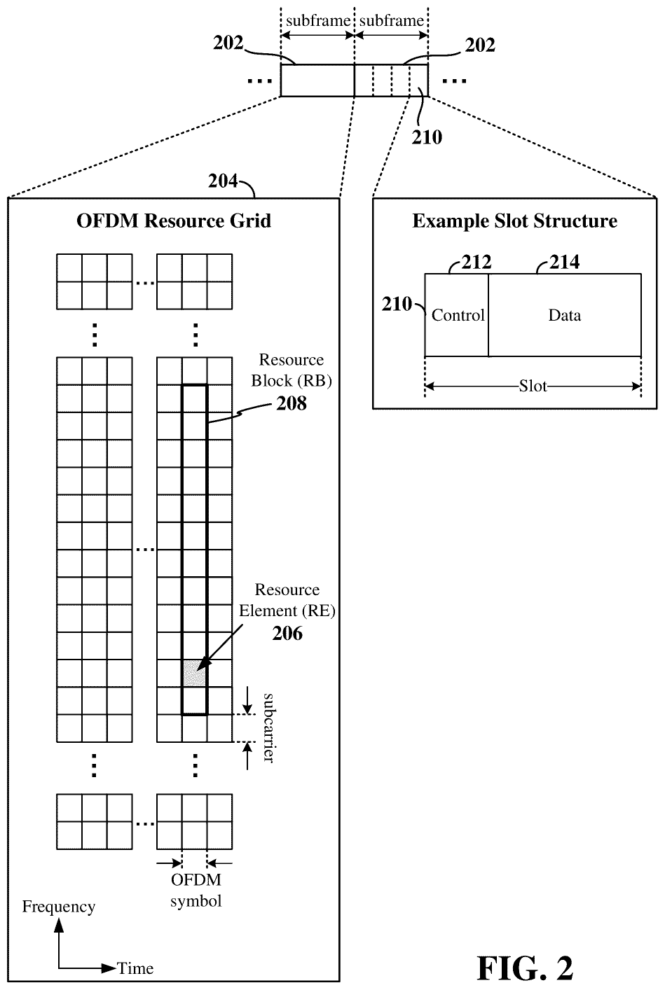

Various aspects of the present disclosure will be described with reference to an OFDM waveform, schematically illustrated in FIG. 2. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 2, an expanded view of an exemplary subframe 202 is illustrated, showing an OFDM resource grid. However, as those skilled in the art will readily appreciate, the PHY transmission structure for any particular application may vary from the example described here, depending on any number of factors. Here, time is in the horizontal direction with units of OFDM symbols; and frequency is in the vertical direction with units of subcarriers of the carrier.

The resource grid 204 may be used to schematically represent time-frequency resources for a given antenna port. That is, in a multiple-input-multiple-output (MIMO) implementation with multiple antenna ports available, a corresponding multiple number of resource grids 204 may be available for communication. The resource grid 204 is divided into multiple resource elements (REs) 206. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 208, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 208 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of UEs or sidelink devices (hereinafter collectively referred to as UEs) for downlink, uplink, or sidelink transmissions typically involves scheduling one or more resource elements 206 within one or more sub-bands or bandwidth parts (BWPs). Thus, a UE generally utilizes only a subset of the resource grid 204. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a base station (e.g., gNB, eNB, etc.) or may be self-scheduled by a UE/sidelink device implementing D2D sidelink communication.

In this illustration, the RB 208 is shown as occupying less than the entire bandwidth of the subframe 202, with some subcarriers illustrated above and below the RB 208. In a given implementation, the subframe 202 may have a bandwidth corresponding to any number of one or more RBs 208. Further, in this illustration, the RB 208 is shown as occupying less than the entire duration of the subframe 202, although this is merely one possible example.

Each 1 ms subframe 202 may consist of one or multiple adjacent slots. In the example shown in FIG. 2, one subframe 202 includes four slots 210, as an illustrative example. In some examples, a slot may be defined according to a specified number of OFDM symbols with a given cyclic prefix (CP) length. For example, a slot may include 7 or 12 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 210 illustrates the slot 210 including a control region 212 and a data region 214. In general, the control region 212 may carry control channels, and the data region 214 may carry data channels. Of course, a slot may contain all DL, all UL, or at least one DL portion and at least one UL portion. The structure illustrated in FIG. 2 is merely exemplary in nature, and different slot structures may be utilized, and may include one or more of each of the control region(s) and data region(s).

Although not illustrated in FIG. 2, the various REs 206 within a RB 208 may be scheduled to carry one or more physical channels, including control channels, shared channels, data channels, etc. Other REs 206 within the RB 208 may also carry pilots or reference signals. These pilots or reference signals may provide for a receiving device to perform channel estimation of the corresponding channel, which may enable coherent demodulation/detection of the control and/or data channels within the RB 208.

In some examples, the slot 210 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a base station) may allocate one or more REs 206 (e.g., within the control region 212) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry HARQ feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 206 (e.g., in the control region 212 or the data region 214) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 20, 80, or 120 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information.

In an UL transmission, the scheduled entity (e.g., UE) may utilize one or more REs 206 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 206 (e.g., within the data region 214) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 206 within the data region 214 may be configured to carry other signals, such as one or more SIBs and DMRSs.

In an example of sidelink communication over a sidelink carrier via a PC5 interface, the control region 212 of the slot 210 may include a physical sidelink control channel (PSCCH) including sidelink control information (SCI) transmitted by an initiating (transmitting) sidelink device (e.g., Tx V2X device or other Tx UE) towards a set of one or more other receiving sidelink devices (e.g., Rx V2X device or other Rx UE). The data region 214 of the slot 210 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 206 within slot 210. For example, HARQ feedback information may be transmitted in a physical sidelink feedback channel (PSFCH) within the slot 210 from the receiving sidelink device to the transmitting sidelink device. In addition, one or more reference signals, such as a sidelink SSB, a sidelink CSI-RS, a sidelink SRS, a sidelink DMRS, and/or a sidelink positioning reference signal (PRS) may be transmitted within the slot 210.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers illustrated in FIG. 2 are not necessarily all of the channels or carriers that may be utilized between devices, and those of ordinary skill in the art will recognize that other channels or carriers may be utilized in addition to those illustrated, such as other traffic, control, and feedback channels.

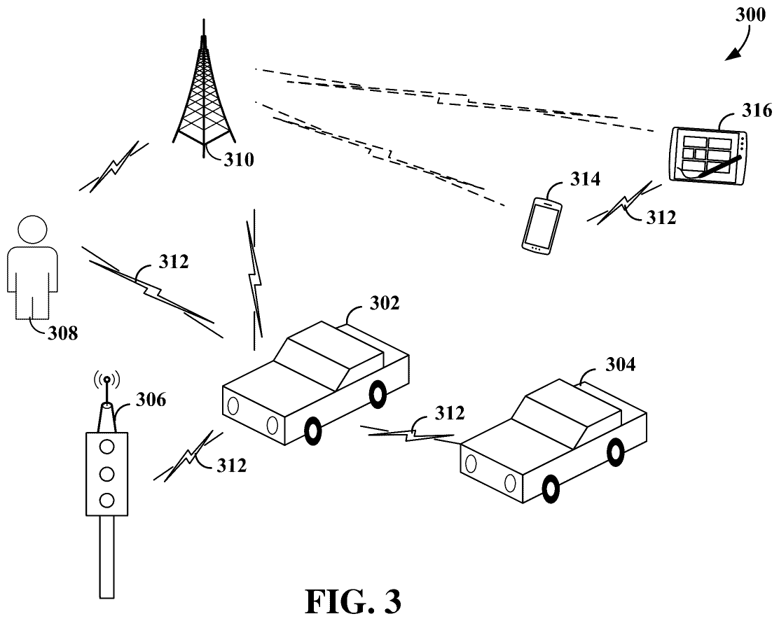

FIG. 3 illustrates an example of a wireless communication network 300 configured to support sidelink communication. In some examples, sidelink communication may include V2X communication. V2X communication involves the wireless exchange of information directly between not only vehicles (e.g., vehicles 302 and 304) themselves, but also directly between vehicles 302/304 and infrastructure (e.g., roadside units (RSUs) 306), such as streetlights, buildings, traffic cameras, tollbooths or other stationary objects, vehicles 302/304 and pedestrians 308, and vehicles 302/304 and wireless communication networks (e.g., base station 310). In some examples, V2X communication may be implemented in accordance with the New Radio (NR) cellular V2X standard defined by 3GPP, Release 16, or other suitable standard.

V2X communication enables vehicles 302 and 304 to obtain information related to the weather, nearby accidents, road conditions, activities of nearby vehicles and pedestrians, objects nearby the vehicle, and other pertinent information that may be utilized to improve the vehicle driving experience and increase vehicle safety. For example, such V2X data may enable autonomous driving and improve road safety and traffic efficiency. For example, the exchanged V2X data may be utilized by a V2X connected vehicle 302 and 304 to provide in-vehicle collision warnings, road hazard warnings, approaching emergency vehicle warnings, pre-/post-crash warnings and information, emergency brake warnings, traffic jam ahead warnings, lane change warnings, intelligent navigation services, and other similar information. In addition, V2X data received by a V2X connected mobile device of a pedestrian/cyclist 308 may be utilized to trigger a warning sound, vibration, flashing light, etc., in case of imminent danger.

The sidelink communication between vehicle-UEs (V-UEs) 302 and 304 or between a V-UE 302 or 304 and either an RSU 306 or a pedestrian-UE (P-UE) 308 may occur over a sidelink 312 utilizing a proximity service (ProSe) PC5 interface. In various aspects of the disclosure, the PC5 interface may further be utilized to support D2D sidelink 312 communication in other proximity use cases (e.g., other than V2X). Examples of other proximity use cases may include smart wearables, public safety, or commercial (e.g., entertainment, education, office, medical, and/or interactive) based proximity services. In the example shown in FIG. 3, ProSe communication may further occur between UEs 314 and 316.

ProSe communication may support different operational scenarios, such as in-coverage, out-of-coverage, and partial coverage. Out-of-coverage refers to a scenario in which UEs (e.g., UEs 314 and 316) are outside of the coverage area of a base station (e.g., base station 310), but each are still configured for ProSe communication. Partial coverage refers to a scenario in which some of the UEs (e.g., V-UE 304) are outside of the coverage area of the base station 310, while other UEs (e.g., V-UE 302 and P-UE 308) are in communication with the base station 310. In-coverage refers to a scenario in which UEs (e.g., V-UE 302 and P-UE 308) are in communication with the base station 310 (e.g., gNB) via a Uu (e.g., cellular interface) connection to receive ProSe service authorization and provisioning information to support ProSe operations.

To facilitate D2D sidelink communication between, for example, UEs 314 and 316 over the sidelink 312, the UEs 314 and 316 may transmit discovery signals therebetween. In some examples, each discovery signal may include a synchronization signal, such as a primary synchronization signal (PSS) and/or a secondary synchronization signal (SSS) that facilitates device discovery and enables synchronization of communication on the sidelink 312. For example, the discovery signal may be utilized by the UE 316 to measure the signal strength and channel status of a potential sidelink (e.g., sidelink 312) with another UE (e.g., UE 314). The UE 316 may utilize the measurement results to select a UE (e.g., UE 314) for sidelink communication or relay communication.

In 5G NR sidelink, sidelink communication may utilize transmission or reception resource pools. For example, the minimum resource allocation unit in frequency may be a sub-channel (e.g., which may include, for example, 10, 15, 20, 25, 50, 75, or 100 consecutive resource blocks) and the minimum resource allocation unit in time may be one slot. The number of sub-channels in a resource pool may include between one and twenty-seven sub-channels. A radio resource control (RRC) configuration of the resource pools may be either pre-configured (e.g., a factory setting on the UE determined, for example, by sidelink standards or specifications) or configured by a base station (e.g., base station 310).

In addition, there may be two main resource allocation modes of operation for sidelink (e.g., PC5) communications. In a first mode, Mode 1, a base station (e.g., gNB) 310 may allocate resources to sidelink devices (e.g., V2X devices or other sidelink devices) for sidelink communication between the sidelink devices in various manners. For example, the base station 310 may allocate sidelink resources dynamically (e.g., a dynamic grant) to sidelink devices, in response to requests for sidelink resources from the sidelink devices. For example, the base station 310 may schedule the sidelink communication via DCI 3_0. In some examples, the base station 310 may schedule the PSCCH/PSSCH within uplink resources indicated in DCI 3_0. The base station 310 may further activate preconfigured sidelink grants (e.g., configured grants) for sidelink communication among the sidelink devices. In some examples, the base station 310 may activate a configured grant (CG) via RRC signaling. In Mode 1, sidelink feedback may be reported back to the base station 310 by a transmitting sidelink device.

In a second mode, Mode 2, the sidelink devices may autonomously select sidelink resources for sidelink communication therebetween. In some examples, a transmitting sidelink device may perform resource/channel sensing to select resources (e.g., sub-channels) on the sidelink channel that are unoccupied. Signaling on the sidelink is the same between the two modes. Therefore, from a receiver's point of view, there is no difference between the modes.

An NR-U network can support the use of a shared spectrum or unlicensed spectrum. An NR-U network can use a shared/unlicensed spectrum to provide wireless access to wireless devices (e.g., gNB or UE). In this disclosure, a channel may refer to a carrier or a part of a carrier consisting of a contiguous set of resource blocks (e.g., RBs 308) on which a channel access procedure may be performed in the shared spectrum. A channel access procedure for NR-U is a procedure based on channel sensing that evaluates the availability (e.g., idle or busy) of a channel for performing signal transmissions. The basic unit for sensing is a sensing slot (e.g., 9 μs slot) with a predetermined duration. In one example, a wireless device (e.g., gNB or UE) can detect the energy of signals transmitted by other devices (e.g., via a received signal strength indication (RSSI)) for a predetermined interval (e.g., 4 μs) within a sensing slot. The sensing slot is considered to be idle when the sensed energy is less than a certain energy detection (ED) threshold; otherwise, the sensing slot is considered to be busy (i.e., not available).

A channel occupancy time (COT) refers to the total time for which a wireless device (e.g., gNB or UE) and another device (e.g., gNB or UE) sharing the COT can perform transmission(s) on a channel after the wireless device performs the corresponding channel access procedure. In one aspect, for determining a COT, if a transmission gap between transmissions is less than or equal to a predetermined gap duration (e.g., 25 μs), the gap duration is counted in the COT. In one example, a base station (e.g., cNB or gNB) and a UE can share a COT for UL and DL transmissions between the base station and the UE.

A DL transmission burst (DL burst) is defined as a set of transmissions from a scheduling entity (e.g., base station, eNB, or gNB) without any gaps between transmissions greater than 16 μs. Transmissions from a scheduling entity separated by a gap of more than 16 μs are considered as separate DL transmission bursts. In other aspects, other suitable time gaps can be used to define a DL transmission burst. A scheduling entity can perform DL transmission(s) after a gap within a DL transmission burst without sensing the corresponding channel(s) for availability. A UL transmission burst is defined as a set of transmissions from a scheduled entity (e.g., UE) without any gaps greater than 16 μs. A UE can perform UL transmission(s) after a gap within an UL transmission burst without sensing the corresponding channel(s) for availability. Transmissions from a UE separated by a gap of more than 16 μs are considered as separate UL transmission bursts. In other aspects, other suitable time gaps can be used to define a DL transmission burst or UL transmission burst.

Two types of channel access procedures for NR-U are available (e.g., type 1 and type 2). Each type of channel access procedure utilizes a different listen-before-talk (LBT) procedure. LBT procedures may involve sensing energy on the channel and comparing the energy to an energy detection (ED) threshold. For example, if the detected energy on the channel is at or below the ED threshold level (e.g., indicating that the channel is relatively free of traffic), the wireless device can gain access to the channel for a transmission. For NR-U, there are four LBT categories defined for channel access. Category 1 (Cat1) LBT specifies that LBT is not used. Category 2 (Cat2) LBT specifies the use of LBT without random back-off. Category 3 (Cat3) LBT specifies the use of LBT with random back-off with a fixed size contention window. Category 4 (Cat4) LBT specifies the use of LBT with random back-off with a variable sized contention window.

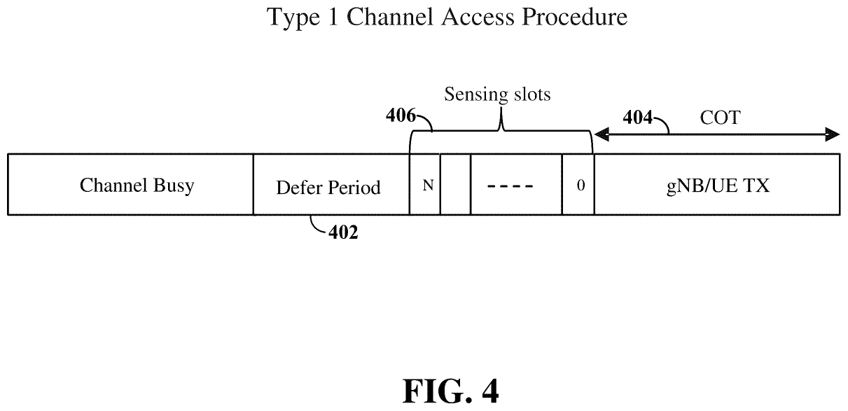

In a type 1 channel access procedure, a wireless device (e.g., gNB or UE) performs a Cat4 LBT, in which the channel access procedure is performed in a time duration spanned by a random number of sensing slots (corresponding to a random back-off) to locate an idle channel before transmission. FIG. 4 illustrates a first type (Type 1) of channel access procedure. After a defer period 402 following a busy channel, a wireless device may transmit (UL or DL transmission burst) in a COT 404 after first sensing the channel to be idle during a random number of sensing slots 406 (e.g., mp consecutive sensing slots) in a defer duration. The random number of sensing slots 406 may be selected from a set of possible back-off values (e.g., values within a variable sized contention window). In some examples, the random number of sensing slots 406 may be based on a channel access priority class (CAPC) of the wireless device.

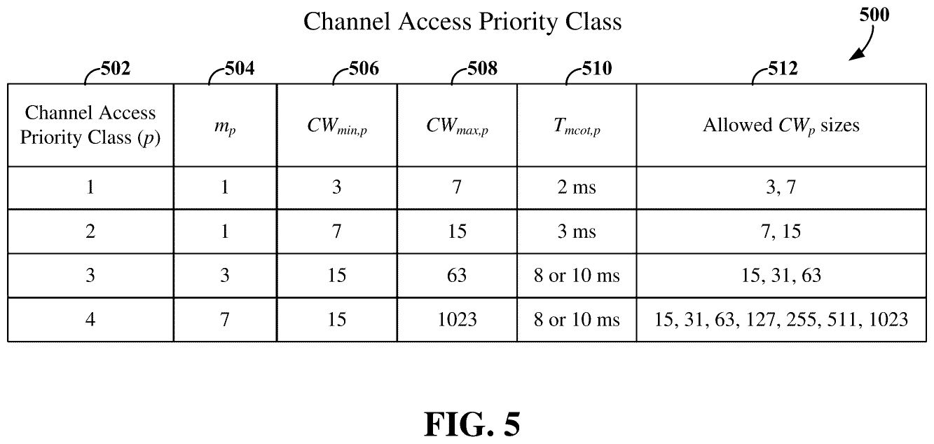

FIG. 5 is a table 500 illustrating various parameters that can be used in the type 1 channel access procedure for different channel access priority classes. For example, each channel access priority class (CAPC) 502 has various parameters including a maximum contention window CWmax,p 508, a minimum contention window CWmin,p 506, a maximum channel occupancy time Tmcot,p 510, a number of consecutive sensing slots mp 504, and allowed CWp (e.g., CWmax,p and CWmin,p) sizes 512. These parameters have different values based on the CAPC (p). The wireless device may not transmit on a channel for a COT that exceeds Tmcot,p 510. The random number of sensing slots can be based on CWmin,p 506 and CWmax,p 508.

In the type 2 channel access procedure, a wireless device (e.g., gNB or UE) performs the channel access procedure in a time duration spanned by a deterministic number of sensing slots to determine an available (e.g., idle) channel before transmission. In some aspects, three kinds of type 2 channel access procedure are available: type 2A, type 2B, and type 2C.

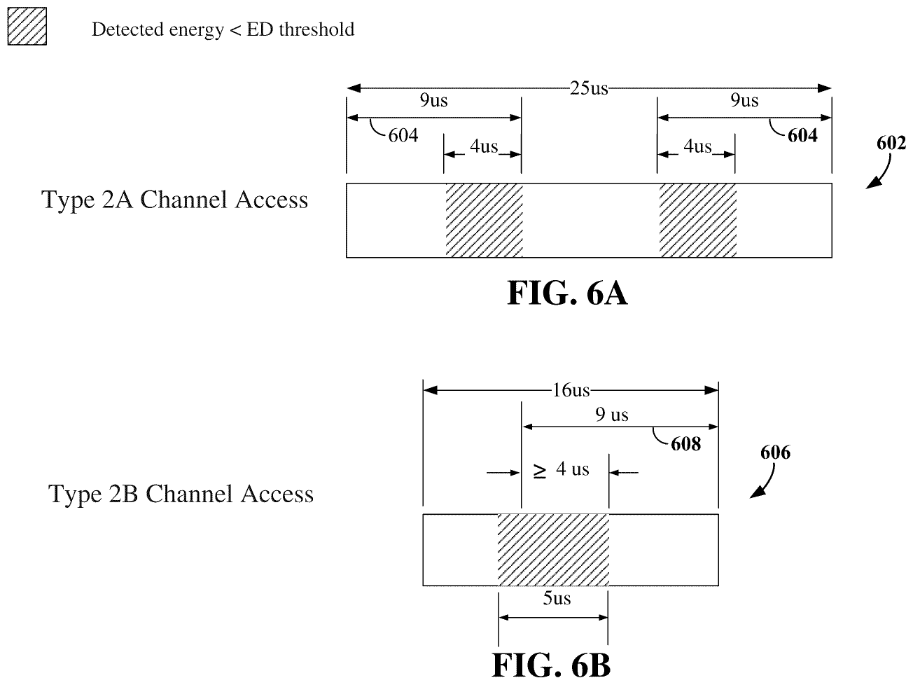

FIG. 6A illustrates an exemplary type 2A sensing interval 602 that includes two sensing slots 604. In a type 2A channel access procedure, a wireless device performs a Cat 2 LBT procedure. For type 2A channel access, the wireless device may transmit after sensing the channel to be available (e.g., idle) for a fixed sensing interval of 25 μs. For example, the channel is considered to be available if the wireless device senses that the channel is idle in both sensing slots 604. The wireless device may sense that the channel is idle by comparing the detected (measured) energy on the channel to an energy detection (ED) threshold. If the detected energy is less than the ED threshold, the channel may be considered idle. In one aspect, the type 2A channel access procedure may be used when the gap between a DL transmission burst and a following UL transmission burst is greater than or equal to 25 μs, and when the gap between an UL transmission burst and a following DL transmission burst is equal to 25 μs.

FIG. 6B also illustrates an exemplary type 2B sensing interval 606 that includes one sensing slot 608. In a type 2B channel access procedure, a wireless device also performs a Cat2 LBT procedure. For type 2B channel access, the wireless device may transmit after sensing the channel to be available (e.g., idle) within a sensing interval of at least 16 μs. In one aspect, the channel is considered to be available if the wireless device senses that the channel is idle in the sensing slot 608. In one example, the channel is available if the channel is sensed to be idle for a total of at least 5 μs with at least 4 μs of sensing occurring in the sensing slot 608. The type 2B channel access procedure may be used when the gap between a UL/DL transmission burst and a following UL/DL transmission burst is equal to 16 μs, and when the gap between an UL transmission burst and a following DL transmission burst is equal to 25 μs.

In a type 2C channel access procedure, a wireless device may perform a Cat1 LBT, in which the wireless device may transmit without first sensing the channel, unlike the type 2A and type 2B channel access procedures described above in relation to FIGS. 6A and 6B. For example, the type 2C channel access procedure may be used when the gap between an UL/DL transmission burst and a following UL/DL transmission burst is smaller than or equal to 16 μs, and a duration of the transmission burst is at most 584 μs. In this case, the wireless device can omit sensing the channel before transmission.

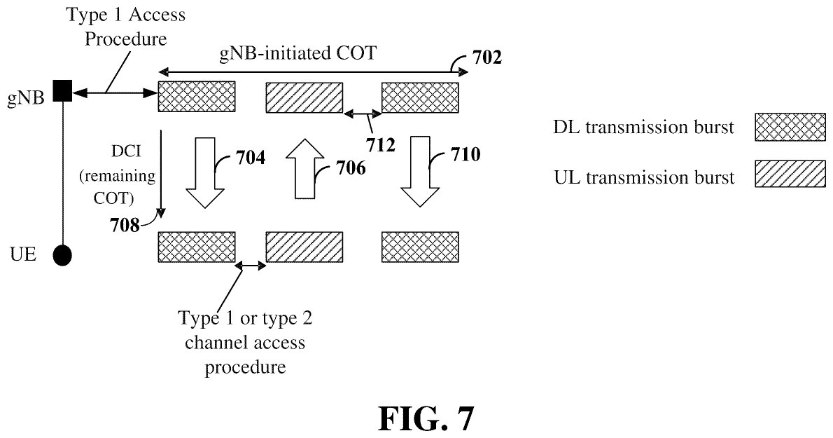

In some examples, a network access node can share a COT initiated by the network access node with one or more wireless communication devices for both downlink and uplink communication. FIG. 7 is a diagram illustrating a channel occupancy time (COT) 702 that is initiated by a network access node (e.g., scheduling entity, gNB, or base station) for a DL transmission burst (e.g., DL transmission burst 704 in FIG. 7) using a type 1 channel access procedure. In one aspect, a base station can share the COT 702 with a UE that can transmit an UL transmission burst 706 including uplink control information and/or uplink data in the same COT 702 using a type 1 or type 2 channel access procedure when certain conditions are met (e.g., remaining time in the COT after the first DL transmission burst 704). In some aspects, the UE can determine the remaining time of the COT 702 initiated by the base station based on downlink control information (DCI) 708 that is transmitted by the base station. For example, the downlink control information 708 (e.g., DCI 2_0) can carry an SFI (slot format indication) that is extended to carry a COT structure indication (COT-SI). The COT-SI indicates the COT resources (e.g., time and frequency resources) of the COT that may be shared with uplink. In some examples, the COT-SI may include a frequency bitmap to indicate the available LBT bandwidths in the frequency domain and a COT duration bit field per serving cell that indicates a remaining length (duration) from the beginning of a slot within which the DCI format 2_0 containing the COT-SI is received. Thus, the UE may determine the remaining time of the COT based on the COT-SI. In some aspects, after the UL transmission burst 706, the base station can transmit additional DL transmission bursts (e.g., transmission burst 710) using the type 2 channel access procedure within the COT 702 if the UL-DL gap 712 can meet certain conditions.

In some aspects, the base station sends an uplink (UL) grant (e.g., in a DCI 0_1 for a PUSCH) or a downlink (DL) assignment (e.g., in a DCI 1_0 for an ACK/NACK carried in a PUCCH) to indicate or signal the LBT type for channel access to be used by the UE for the UL transmission burst. Based on the LBT type indicated via the UL grant, the UE can determine a type 1 or type 2 (e.g., type 2A/2B/2C) channel access procedure for the UL transmission burst.

In some examples, the UL grant (e.g., DCI 0_1) indicates the LBT type, along with the CAPC and a length (e.g., duration) of a cyclic prefix (CP) extension to be added to the UL transmission. In many cases, a tight gap needs to be generated for the proper LBT type (e.g., Cat1 LBT with 16 μs, Cat2 LBT with 16 μs, Cat2 with 25 μs, or Cat 4 LBT) to be applied. To maintain the tight gap, a CP extension with a configurable length based on the LBT type and CAPC is applied. The CP extension is located in the symbol(s) immediately preceding the UL transmission. The supported durations for the CP extension include:
0 (e.g., no CP extension),
C₁*symbol length−25 μs,
C₂*symbol length−16 μs−TA, or
C₃*symbol length−25 μs−TA,
   where C1=1 for subcarrier spacings of 15 kHz and 30 kH and C1=2 for 60 kHz subcarrier spacing, C2 and C3 are UE-specific and RRC configured, and the TA is the timing advance for the UE. The supported range of values for both C2 and C3 that can be configured by RRC include: {1, 2, . . . , 28} for 15 kHz and 30 kHz subcarrier spacing and {2, 3, . . . , 28} for 60 kHz subcarrier spacing. The maximum value of the CP extension for all subcarrier spacings is one OFDM symbol.

A subset of allowed combinations of LBT type, CP extension length, and CAPC (e.g., CAPC 1, CAPC 2, CAPC 3, or CAPC 4, as shown in FIG. 5) may be configured for the UE via RRC signaling. For example, disallowed combinations (e.g., combinations not included in the RRC configuration) may include a combination of Cat2 LBT with 25 μs and C2*symbol length−16 μs−TA, a combination of Cat1 LBT with 16 μs and C₃*symbol length−25 μs−TA, a combination of Cat2 with 16 us and C₃*symbol length−25 μs−TA, and a combination of Cat 1 with 16 μs or Cat2 with 16 us and C1*symbol length−25 us.

The DCI 0_1 may include one of the allowed combinations of LBT type, CP extension length, and CAPC indicated by the RRC signaling. For example, the DCI 0_1 may include a bitfield of up to six bits, depending on the number of allowed combinations indicated by the RRC signaling.

In various aspects of the disclosure, to make efficient use of a gNB-initiated COT, the gNB (e.g., network access node) may share the gNB-initiated COT with one or more UEs for sidelink communication. Thus, the gNB-initiated COT may be used for both downlink and sidelink communication. In some examples, the gNB-initiated COT may further be used for uplink communication, as described above in connection with FIG. 7.

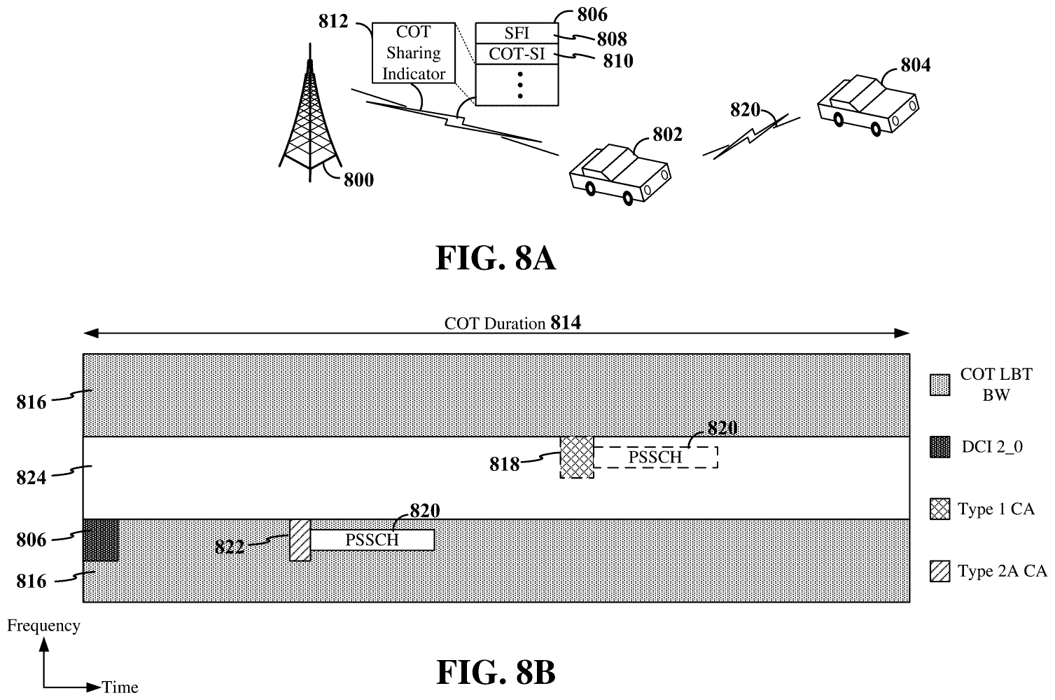

FIGS. 8A and 8B illustrate an example of COT sidelink sharing according to some aspects. As shown in FIG. 8A, a network access node (e.g., a base station, such as a gNB) 800 is in communication with a wireless communication device (e.g., a UE, such as a V2X or other sidelink device) 802 via a cellular (Uu) link. The wireless communication device 802 is further in communication with another wireless communication device 804 via a sidelink.

The network access node 800 can transmit downlink control information (DCI) 806 including a COT structure indication (COT-SI) 810 to the wireless communication device 802. In the example shown in FIG. 8A, the DCI 806 is DCI format 2_0, which may further include a slot format indicator (SFI) 808 and one or more other fields and/or parameters. The COT-SI 810 indicates the time domain and frequency domain of the COT structure. For example, the COT-SI 810 may include a frequency bitmap to indicate the available LBT bandwidths in the frequency domain and a COT duration bit field per serving cell that indicates a remaining length (duration) from the beginning of a slot within which the DCI format 2_0 806 containing the COT-SI 810 is received.

In an aspect of the disclosure, the COT-SI 810 included in the DCI 2_0 806 may be reused for (e.g., shared with) sidelink communication. In some examples, sharing of gNB-initiated COTs with sidelink communication may be enabled or disabled. In some examples, COT sidelink sharing may be pre-configured on the wireless communication device 802 (e.g., via the OEM based on one or more standards or specifications). In other examples, COT sidelink sharing may be enabled or disabled by the network access node 800. For example, the network access node 800 can transmit a message including a COT sharing indicator 814 to the wireless communication device 802. The COT sharing indicator 812 indicates whether COT sidelink sharing is enabled or disabled. In some examples, the message may include an RRC message. In this example, the COT sharing indicator 812 may be a new RRC parameter. In other examples, the message may include the DCI 2_0 806, as indicated by the dotted lines in FIG. 8A. In this example, the COT sharing indicator 812 may include a bit value set to zero if COT sidelink sharing is disabled and to one if COT sidelink sharing is enabled.

In examples in which COT sidelink sharing is enabled (e.g., by pre-configuration or based on the COT sharing indicator 812), the wireless communication device 802 may share the network access node-initiated COT defined in the COT-SI 810 for sidelink communication with another wireless communication device (e.g., wireless communication device 804). As shown in FIGS. 8A and 8B, the COT-SI 810 included DCI 2_0 806 indicates a COT duration 814 and LBT bandwidths 816 of the network access node-initiated COT. Upon receiving the DCI 2_0 806, the wireless communication device 802 can determine a duration in the time domain and LBT bandwidths in the frequency domain of a remaining COT initiated by the network access node 800. The wireless communication device 802 may then determine whether or not to share the COT for a sidelink transmission 820 from wireless communication device 802 to at least wireless communication device 804.

In examples in which the wireless communication device 802 determines to transmit the sidelink transmission 820 within external resources 824 outside of the COT resources 814/816, the wireless communication device 802 may utilize a first channel access procedure type to gain access to a wireless channel (e.g., frequency band) within the external resources 824. In the example shown in FIG. 8B, the first channel access procedure type includes a Type 1 channel access procedure 818. The Type 1 channel access (CA) procedure 818 utilizes Cat4 LBT with a random back-off.

In examples in which the wireless communication device 802 determines to transmit the sidelink transmission 820 within the COT resources 814/816, the wireless communication device 802 may utilize a second channel access procedure type to gain access to a wireless channel within the COT resources 814/816. In the example shown in FIG. 8B, the second channel access procedure type includes a Type 2A channel access procedure 822. The Type 2A channel access (CA) procedure 822 utilizes Cat2 LBT with a fixed sensing period of 25 μs. In some examples, the Type 2A CA procedure 822 may have a shorter LBT period than the Type 1 CA procedure 818, thus reducing the processing and power requirements for the wireless communication device 802. In addition, the Type 2A CA procedure 822 may further reduce the latency of the sidelink transmission 820, depending on the resources selected for the sidelink transmission 820 within the COT resources 814/816.

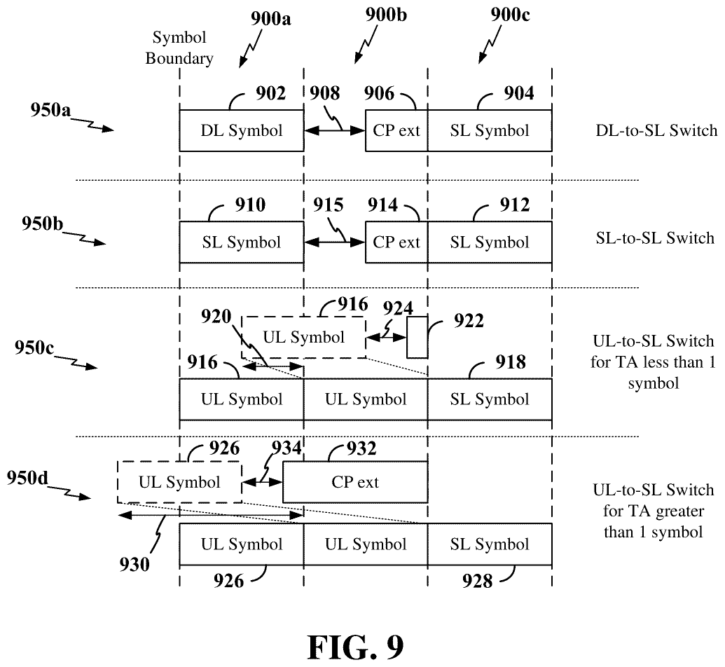

FIG. 9 is a diagram illustrating an example of COT sharing between downlink, uplink, and sidelink according to some aspects. In the example shown in FIG. 9, three symbols (e.g., OFDM symbols) 900a, 900b, and 900c of the COT are shown, for simplicity. In addition, FIG. 9 further illustrates four different COT sidelink sharing scenarios between the three symbols 900a, 900b, and 900c. In a first COT sidelink sharing scenario 950a, the COT is used for a downlink (DL) transmission 902 in symbol 900a and a sidelink transmission 904 in symbol 900c. Thus, in this example, there is a DL-to-SL switch between symbol 900a and symbol 900c. As with COT uplink sharing, in COT sidelink sharing, a tight gap 908 may need to be generated for the proper LBT type (e.g., Cat1 LBT with 16 μs gap, Cat2 LBT with 16 μs gap, Cat2 with 25 μs gap, or Cat 4 LBT with random back-off) to be applied. The gap 908 may be used for channel sensing (e.g., energy detection). To maintain the tight gap 908, a CP extension (CP ext) 906 based on the LBT type and CAPC is applied to the SL transmission 904. The CP extension 906 is located in the symbol 900b immediately preceding the SL transmission 904.

In a second COT sidelink sharing scenario 950b, the COT is used for a first SL transmission 910 in the first symbol 900a and a different second SL transmission 912 (e.g., by the same or a different wireless communication device) in the third symbol 900c. Thus, there is a SL-to-SL switch between symbol 900a and symbol 900c. As in the first COT sidelink sharing scenario 950a, a CP extension 914 is added to the beginning of the second SL transmission 912 and is located in the symbol 900b immediately preceding the second SL transmission 912. The CP extension 914 facilitates a proper gap 915 between the first SL transmission 910 and the second SL transmission 912 based on the LBT type and CAPC.

In a third COT sidelink sharing scenario 950c, the COT is used for an uplink (UL) transmission 916 in symbols 900a and 900b and a SL transmission 918 in symbol 900c. Thus, there is an UL-to-SL switch between symbol 900b and symbol 900c. For uplink transmissions, a wireless communication device may adjust the transmission timing of the UL transmission 916 by a timing advance (TA) 920 to compensate for the propagation delay as the UL transmission 916 travels from the wireless communication device to the network access node. In the third COT sidelink sharing scenario 950c, the TA is less than a symbol. Therefore, to maintain the proper gap 924 for the LBT type between the UL transmission 916 within symbol 900b and the SL transmission 918 within symbol 900c, a shorter CP extension 922 may be added to the beginning of the SL transmission 918 within symbol 900b.

In a fourth COT sidelink sharing scenario 950d, the COT is also used for an UL transmission 926 in symbols 900a and 900b and a SL transmission 928 in symbol 900c. In this scenario, the TA 930 is greater than one symbol. Therefore, to maintain the proper gap 934 for the LBT type between the UL transmission 926 and the SL transmission 928, a longer CP extension 932 may be added to the beginning of the SL transmission 928 within symbol 900b.

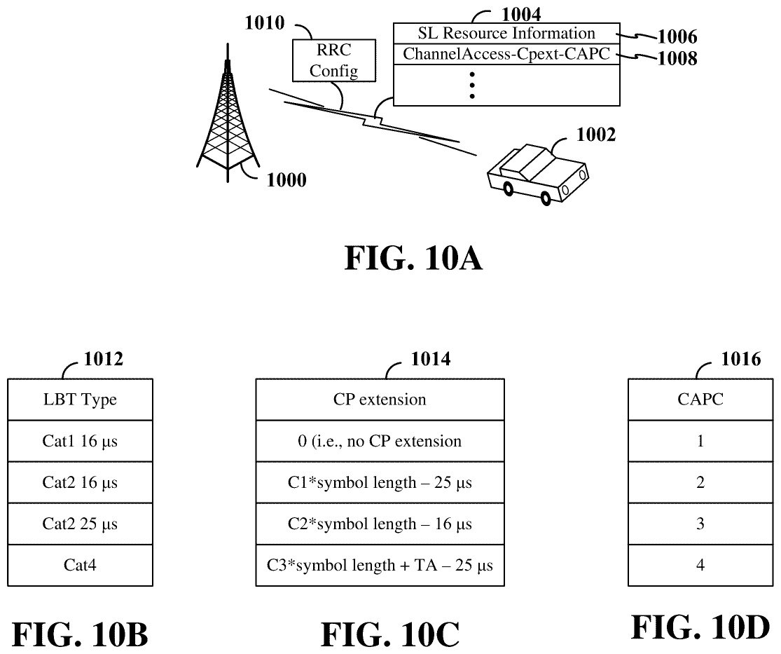

To ensure the wireless communication device applies the correct CP extension length based on the LBT type and CAPC for COT sidelink sharing, the network access node can transmit the CP extension length, along with the corresponding LBT type and CAPC, to the wireless communication device for use in COT sidelink sharing. FIGS. 10A-10D are diagrams illustrating examples of CP extension, LBT type, and CAPC for COT sidelink sharing according to some aspects.

As shown in FIG. 10A, a network access node (e.g., base station, such as a gNB) 1000 is in communication with a wireless communication device (e.g., a UE, such as a V2X or other sidelink device) 1002 via a cellular (Uu) link. The wireless communication device 1002 may further be in communication with another wireless communication device (not shown) via a sidelink. The network access node 1000 can transmit downlink control information (DCI) 1004 including a channel access cyclic prefix extension channel access priority class (ChannelAccess-CPext-CAPC) field 1008 to the wireless communication device 1002. In the example shown in FIG. 10A, the DCI 806 is DCI format 3_0, which may further include SL resource information 1006 (e.g., SL resource pool information) and one or more other fields and/or parameters. The ChannelAccess-CPext-CAPC field indicates an LBT type, a CP extension length, and a CAPC for COT sidelink sharing.

FIG. 10B is a diagram illustrating examples of the LBT types 1012 available for COT sidelink sharing. FIG. 10C is a diagram illustrating examples of the available CP extension lengths 1014 available for COT sidelink sharing. FIG. 10D is a diagram illustrating examples of the CAPCs available for COT sidelink sharing. For example, the available LBT types 1012 may include Cat1 with a 16 μs gap, Cat2 with a 16 μs gap, Cat2 with a 25 μs gap, and Cat 4. In addition, the available CAPCs 1016 include CAPC1, CAPC2, CAPC3, and CAPC4, as shown in more detail in FIG. 5.

The available CP extension lengths 1014 include:
0 (e.g., no CP extension),
C₁*symbol length−25 μs,
C₂*symbol length−16 μs, or
C₃*symbol length+TA−25 μs,
   where C1=1 for subcarrier spacings of 15 kHz and 30 kH and C1=2 for 60 kHz subcarrier spacing, C2 C2=1 for subcarrier spacings of 15 kHz, 30 kHz and 60 kHz and C3 is UE-specific and RRC configured, and the TA is the timing advance for the wireless communication device 1002. In the example shown in FIG. 10C, the CP extension C2*symbol length−16 μs is a new CP extension for supporting DL-to-SL switching. In addition, the CP extension C3*symbol length+TA−25 μs is a new CP extension for supporting UL-to-SL switching.

A subset of allowed combinations of LBT type 1012, CP extension length 1014, and CAPC 1016, as shown in FIGS. 10B, 10C, and 10C, may be configured for the UE via an RRC configuration message 1010 sent from the network access node 1000 to the wireless communication device 1002, as shown in FIG. 10A. For example, disallowed combinations (e.g., combinations not included in the RRC configuration 1010) may include a combination of Cat1 LBT with 16 μs or Cat 2 LBT with 16 μs and C1*symbol length−25 μs (where C1=1 for 15 and 30 kHz subcarrier spacing and C1=2 for 60 kHz subcarrier spacing), a combination of Cat2 LBT with 25 μs and C2*symbol length−16 μs (where C2=1 for 15 kHz, 30 kHz, and 60 kHz subcarrier spacing), and a combination of Cat1 with 16 μs or Cat2 with 16 μs and C3*symbol length+TA−25 μs (where C3 can be configured by a new RRC parameter).

The DCI 3_0 1004 may include one of the allowed combinations of LBT type 1012, CP extension length 1014, and CAPC 1016 indicated by the RRC configuration message 1010. For example, the DCI 3_0 1004 may include a bitfield of up to six bits, depending on the number of allowed combinations indicated by the RRC configuration message 1010.

LBT involves sensing energy on the channel and comparing the energy to an energy detection (ED) threshold. Energy sensing may be performed, for example, during the gap prior to the CP extension for the sidelink transmission based on the LBT type and CAPC for COT sidelink sharing. In some examples, for COT sidelink sharing, the wireless communication device 1002 may reuse the same ED threshold as specified for COT uplink sharing. In other examples, separate ED thresholds may be used for COT sidelink sharing and COT uplink sharing. For example, the network access node 1000 may transmit separate ED threshold parameters for COT sidelink sharing to the wireless communication device 1002. In some examples, the ED threshold parameters may be configured via RRC signaling and may include a sidelink maximum ED threshold (maxEnergyDetectionThreshold-SL) and a sidelink ED threshold offset (energyDetectionThresholdOffset-SL). For example, the ED threshold parameters may be included in the RRC configuration message 1010.

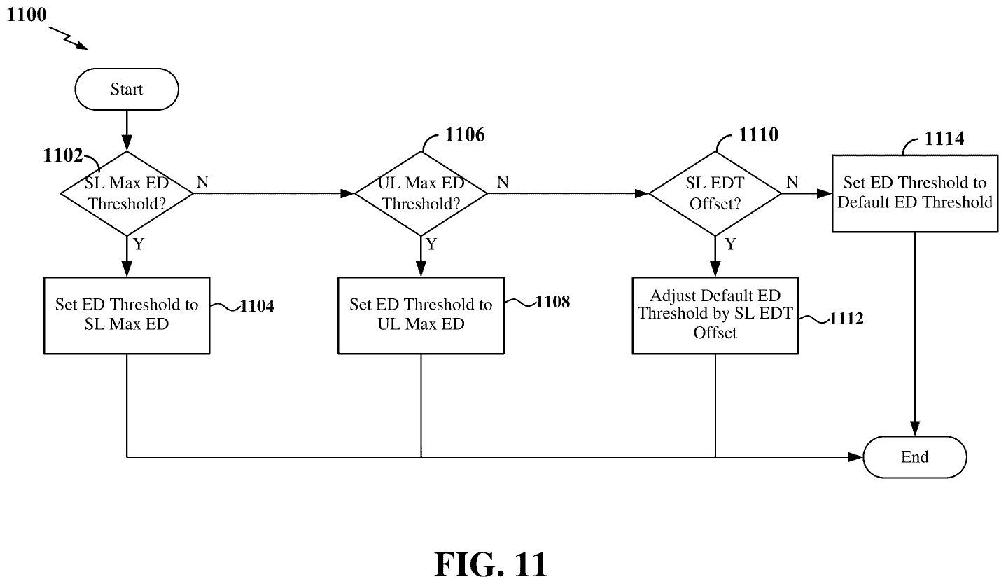

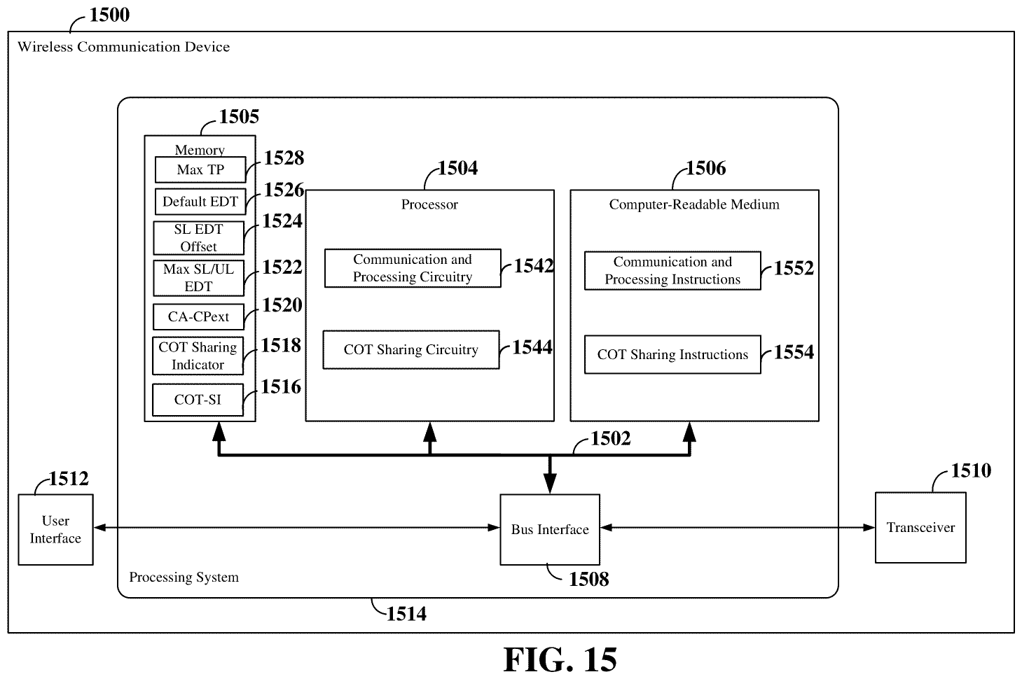

FIG. 11 is a flow chart illustrating an exemplary process 1100 for determining an ED threshold for COT sidelink sharing according to some aspects. As described below, some or all illustrated features may be omitted in a particular implementation within the scope of the present disclosure, and some illustrated features may not be required for implementation of all examples. In some examples, the method may be performed by the wireless communication device 1500, as described below and illustrated in FIG. 15, by a processor or processing system, or by any suitable means for carrying out the described functions.

At block 1102, a wireless communication device (e.g., a UE, such as a V2X or other sidelink device) may determine whether the wireless communication device is configured with a sidelink maximum ED threshold (SL Max ED Threshold). For example, the wireless communication device may receive a higher layer (RRC) parameter, such as maxEnergyDetectionThreshold-SL, from a network access node (e.g., a base station, such as a gNB).

If the wireless communication device is configured with a sidelink maximum ED threshold (Y branch of block 1102), at block 1104, the wireless communication device may set the ED threshold utilized for COT sidelink sharing to the sidelink maximum ED threshold.

If the wireless communication device is not configured with a sidelink maximum ED threshold (N branch of block 1102), at block 1106, the wireless communication device may determine whether the wireless communication device is configured with an uplink maximum ED threshold (UL Max ED Threshold). For example, the wireless communication device may receive a higher layer (RRC) parameter, such as maxEnergyDetectionThreshold-r14 or maxEnergyDetectionThreshold-r16, from the network access node.

If the wireless communication device is configured with an uplink maximum ED threshold (Y branch of block 1106), at block 1108, the wireless communication device may set the ED threshold utilized for COT sidelink sharing to the uplink maximum ED threshold.

If the wireless communication device is not configured with an uplink maximum ED threshold (N branch of block 1106), at block 1110, the wireless communication device may determine whether the wireless communication device is configured with a sidelink ED threshold offset (SL EDT Offset). For example, the wireless communication device may receive a higher layer (RRC) parameter, such as energyDetectionThresholdOffset-SL, from the network access node.

If the wireless communication device is configured with the sidelink ED threshold offset (Y branch of block 1110), at block 1112, the wireless communication device may adjust a default ED threshold by the sidelink ED threshold offset to produce the ED threshold utilized for COT sidelink sharing. If the wireless communication device is not configured with the sidelink ED threshold offset (N branch of block 1110), at block 1112, the wireless communication device may set the ED threshold to the default ED threshold.

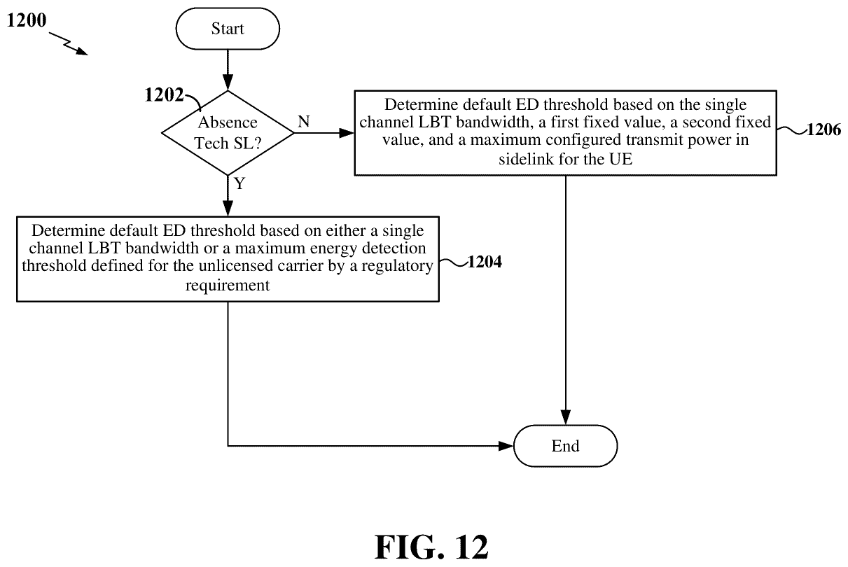

FIG. 12 is a flow chart illustrating an exemplary process 1200 for determining a default ED threshold for COT sidelink sharing according to some aspects. As described below, some or all illustrated features may be omitted in a particular implementation within the scope of the present disclosure, and some illustrated features may not be required for implementation of all examples. In some examples, the method may be performed by the wireless communication device 1500, as described below and illustrated in FIG. 15, by a processor or processing system, or by any suitable means for carrying out the described functions.

At block 1202, a wireless communication device (e.g., a UE, such as a V2X or other sidelink device) may determine whether the wireless communication device is configured with a sidelink absence of any other technology parameter (Absence Tech SL). For example, the wireless communication device may receive a higher layer (RRC) parameter, such as absenceOfAnyOtherTechnology-SL, from a network access node (e.g., a base station, such as a gNB)

If the wireless communication device is configured with the sidelink absence of any other technology parameter (Y branch of block 1202), at block 1204, the wireless communication device may determine the default ED threshold based on either a single channel LBT bandwidth or a maximum energy detection threshold defined for the unlicensed carrier by a regulatory requirement. For example, the wireless communication device may determine the default threshold (X′_{Thresh_max}) as:

$${X}_{Thresh\_max}^{′} = min \{ {T}_{max} + 10 dB , {X}_{r} \} , \qquad ( Equation 1 )$$

where Xᵣ is the maximum ED threshold defined by regulatory requirement in dBm in areas within which such regulatory requirements are defined. In addition, Tₘₐₓ is given by:

$${T}_{max} ( dB m ) = 10 log 10 ( 3.18228 * 1 {0}^{- 8} ( \frac{mW}{MHz} ) * BW MHz ( MHz ) ) , \qquad ( Equation 2 )$$

where BWMHz is the sidelink single channel LBT bandwidth (e.g., the bandwidth of a single channel in sidelink). For example, the sidelink single channel bandwidth may correspond to an LBT bandwidth of 20 MHz.

If the wireless communication device is not configured with a sidelink absence of any other technology parameter (N branch of block 1202), at block 1206, the wireless communication device may determine the default ED threshold based on the single channel LBT bandwidth, a first fixed value, a second fixed value, and a maximum configured transmit power in sidelink for the UE. For example, the wireless communication device may determine the default threshold (X′_{Thresh_max}) as:

$${X}_{Thresh\_max}^{′} = = max \{ - 72 + 10 log 10 ( \frac{BW MHz}{20 MHz} ) dB m , min \{ {T}_{max} , {T}_{max} - {T}_{A} + ( {P}_{H} + 10 log 10 ( \frac{BW MHz}{20 MHz} ) ) - {P}_{T X} \} \} , \qquad ( Equation 3 )$$

where T_{A}=10 dB, P_{H}=23 dBm, and P_{TX} is set to the maximum configured transmit power of the wireless communication device in sidelink. For example, P_{TX} may be set based on the UE category of the wireless communication device.

In some examples, instead of using the single channel LBT bandwidth, the ED threshold may be defined based on an occupied bandwidth. In some examples, the occupied bandwidth may be larger than the single channel LBT bandwidth (e.g., 20 MHz). Therefore, the wireless communication device may adjust the ED threshold to account for the actual occupied bandwidth.

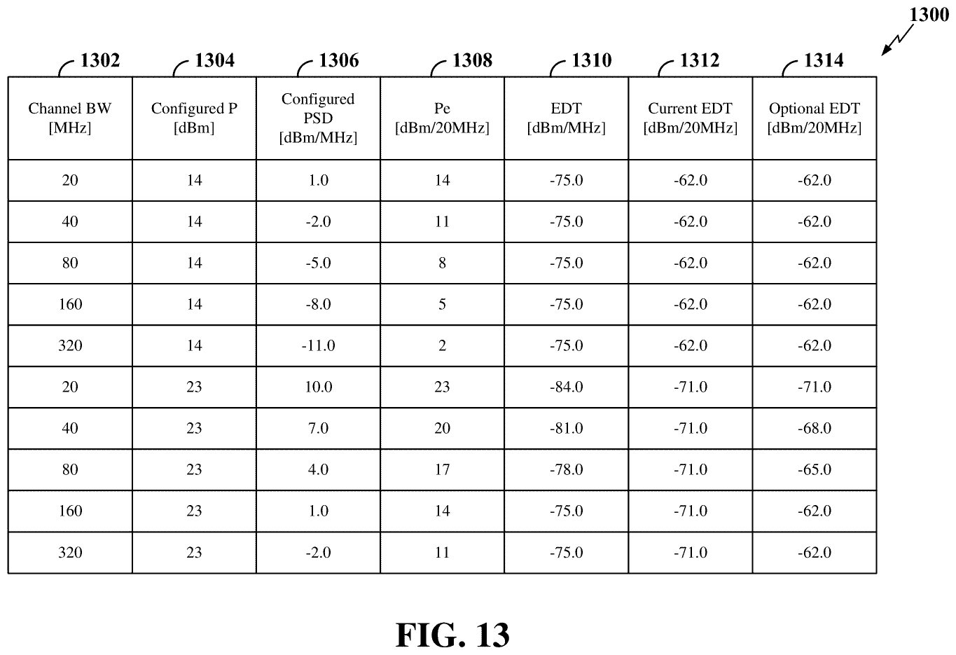

FIG. 13 is a table 1300 illustrating an example of sidelink ED thresholds 1310 and 1314 for COT sidelink sharing according to some aspects. An optional sidelink ED threshold 1314 is based on the single channel LBT bandwidth of 20 MHZ, and corresponds to the existing ED threshold 1312 for uplink based on a maximum configured transmit power 1304 (Configured P [dBm]) of the wireless communication device.

A new sidelink ED threshold 1310 can be determined based on a power spectral density 1306 (Configured PSD [dBm/MHz]) corresponding to the maximum configured transmit power 1304 (Configured P [dBm]) of the wireless communication device per the occupied bandwidth 1302 (Channel BW [MHz]). For example, the sidelink ED threshold 1310 is given by:

$$ED threshold = \{ \begin{matrix}- 75 dBm / MHz & for {P}_{e} \leq 14 dBm \\ - 85 \frac{dBm}{MHz} + 24 dBM - {P}_{e} & for 14 < {P}_{e} < 24 dBm , \\ - 85 dBm / MHz & for {P}_{e} \geq 24 dBm\end{matrix} \qquad ( Equ a t i on 4 )$$

where Pₑ=P−10*log₁₀(occupied BW/20). Thus, Pₑ 1308 is based on the maximum configured transmit power (P) 1304 and the occupied bandwidth 1302. For example, if the occupied bandwidth is 40 MHz and the maximum configured transmit power is 23 dB, the maximum configured transmit power per 20 MHz is 20 dB. Thus, the new ED threshold 1310/1314 may be increased as compared to the existing uplink ED threshold 1312 by 3 dB. Thus, with the above-indicated computation of the new ED threshold 1310, the ED threshold can be relaxed for wideband operation.

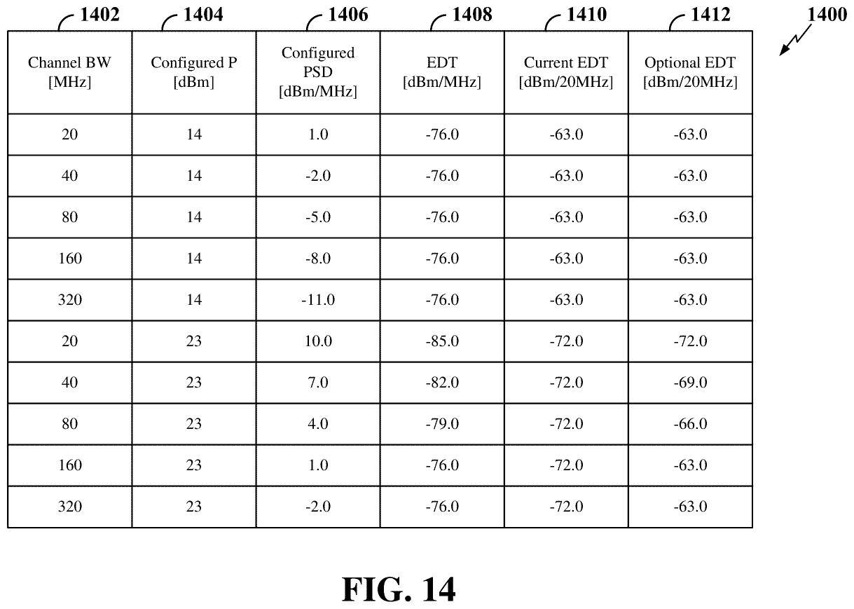

FIG. 14 is a table 1400 illustrating another example of sidelink ED thresholds 1408 and 1412 for COT sidelink sharing according to some aspects. An optional sidelink ED threshold 1412 is based on the single channel LBT bandwidth of 20 MHZ, and corresponds to the existing ED threshold 1410 for uplink based on a maximum configured transmit power 1404 (Configured P [dBm]) of the wireless communication device. The optional sidelink ED threshold 1412 and existing uplink ED threshold 1410 correspond to the optional sidelink ED threshold 1314 and existing uplink ED threshold 1312 shown in FIG. 13

In FIG. 14, the new sidelink ED threshold 1408 is also determined based on the power spectral density 1406 (Configured PSD [dBm/MHz]) corresponding to the maximum configured transmit power 1404 (Configured P [dBm]) of the wireless communication device per the occupied bandwidth 1402 (Channel BW [MHz]). However, in the example shown in FIG. 14, the sidelink ED threshold 1408 is given by:

$$ED threshold = \{ \begin{matrix}- 75 dBm / MHz & for {P}_{e} \leq 14 dBm \\ - 85 \frac{dBm}{MHz} + 24 dBM - {P}_{e} & for 14 < {P}_{e} < 24 dBm , \\ - 85 dBm / MHz & for {P}_{e} \geq 24 dBm\end{matrix} \qquad ( Equ a t i on 4 )$$

where again Pₑ=P−10*log₁₀ (occupied BW/20). Thus, in the example shown in FIG. 14, the new ED threshold 1408 can be further relaxed for wideband operation.

FIG. 15 is a block diagram illustrating an example of a hardware implementation for a wireless communication device 1500 employing a processing system 1514. For example, the wireless communication device 1500 may correspond to a sidelink (e.g., V2X) device, such as an RSU, V-UE, P-UE, or other suitable sidelink device, as shown and described above in reference to FIGS. 1, 3, 7, 8A, or 10A.

The wireless communication device 1500 may be implemented with a processing system 1514 that includes one or more processors 1504. Examples of processors 1504 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the wireless communication device 1500 may be configured to perform any one or more of the functions described herein. That is, the processor 1504, as utilized in the wireless communication device 1500, may be used to implement any one or more of the processes and procedures described below.

The processor 1504 may in some instances be implemented via a baseband or modem chip and in other implementations, the processor 1504 may include a number of devices distinct and different from a baseband or modem chip (e.g., in such scenarios as may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1514 may be implemented with a bus architecture, represented generally by the bus 1502. The bus 1502 may include any number of interconnecting buses and bridges depending on the specific application of the processing system 1514 and the overall design constraints. The bus 1502 links together various circuits including one or more processors (represented generally by the processor 1504), a memory 1505, and computer-readable media (represented generally by the computer-readable medium 1506). The bus 1502 may also link various other circuits such as timing sources, peripherals, voltage regulators, and power management circuits, which are well known in the art, and therefore, will not be described any further.

A bus interface 1508 provides an interface between the bus 1502 and a transceiver 1510. The transceiver 1510 provides a means for communicating with various other apparatus over a transmission medium (e.g., air interface). Depending upon the nature of the apparatus, a user interface 1512 (e.g., keypad, display, touch screen, speaker, microphone, control knobs, etc.) may also be provided. Of course, such a user interface 1512 is optional, and may be omitted in some examples.

The processor 1504 is responsible for managing the bus 1502 and general processing, including the execution of software stored on the computer-readable medium 1506. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software, when executed by the processor 1504, causes the processing system 1514 to perform the various functions described below for any particular apparatus. The computer-readable medium 1506 and the memory 1505 may also be used for storing data that is manipulated by the processor 1504 when executing software. For example, the memory 1505 may store one or more of a channel occupancy time (COT) structure indication (COT-SI) 1516, a COT sharing indicator 1518, channel access cyclic prefix (CP) extension channel access priority class information (CA-CPext) 1520, a sidelink and/or uplink maximum energy detection threshold (EDT) (Max SL/UL EDT) 1522, a sidelink EDT offset 1524, a default EDT 1526, and a maximum configured transmit power in sidelink (Max TP) 1528, which may be used by the processor 1504 in COT sidelink sharing.

The computer-readable medium 1506 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1506 may reside in the processing system 1514, external to the processing system 1514, or distributed across multiple entities including the processing system 1514. The computer-readable medium 1506 may be embodied in a computer program product. By way of example, a computer program product may include a computer-readable medium in packaging materials. In some examples, the computer-readable medium 1506 may be part of the memory 1505. Those skilled in the art will recognize how best to implement the described functionality presented throughout this disclosure depending on the particular application and the overall design constraints imposed on the overall system.

In some aspects of the disclosure, the processor 1504 may include circuitry configured for various functions. For example, the processor 1504 may include communication and processing circuitry 1542, configured to communicate with one or more sidelink devices (e.g., other UEs, such as V2X devices) via respective sidelinks (e.g., PC5 interfaces). In addition, the communication and processing circuitry 1542 may be configured to communicate with a network access node (e.g., a base station, such as a gNB or eNB) via a Uu link. In some examples, the communication and processing circuitry 1542 may include one or more hardware components that provide the physical structure that performs processes related to wireless communication (e.g., signal reception and/or signal transmission) and signal processing (e.g., processing a received signal and/or processing a signal for transmission). For example, the communication and processing circuitry 1542 may include one or more transmit/receive chains.

In some implementations where the communication involves receiving information, the communication and processing circuitry 1542 may obtain information from a component of the wireless communication device 1500 (e.g., from the transceiver 1510 that receives the information via radio frequency signaling or some other type of signaling suitable for the applicable communication medium), process (e.g., decode) the information, and output the processed information. For example, the communication and processing circuitry 1542 may output the information to another component of the processor 1504, to the memory 1505, or to the bus interface 1508. In some examples, the communication and processing circuitry 1542 may receive one or more of signals, messages, other information, or any combination thereof. In some examples, the communication and processing circuitry 1542 may receive information via one or more channels. In some examples, the communication and processing circuitry 1542 may include functionality for a means for receiving. In some examples, the communication and processing circuitry 1542 may include functionality for a means for processing, including a means for demodulating, a means for decoding, etc.

In some implementations where the communication involves sending (e.g., transmitting) information, the communication and processing circuitry 1542 may obtain information (e.g., from another component of the processor 1504, the memory 1505, or the bus interface 1508), process (e.g., modulate, encode, etc.) the information, and output the processed information. For example, the communication and processing circuitry 1542 may output the information to the transceiver 1510 (e.g., that transmits the information via radio frequency signaling or some other type of signaling suitable for the applicable communication medium). In some examples, the communication and processing circuitry 1542 may send one or more of signals, messages, other information, or any combination thereof. In some examples, the communication and processing circuitry 1542 may send information via one or more channels. In some examples, the communication and processing circuitry 1542 may include functionality for a means for sending (e.g., a means for transmitting). In some examples, the communication and processing circuitry 1542 may include functionality for a means for generating, including a means for modulating, a means for encoding, etc.

The communication and processing circuitry 1542 may be configured to receive, via the transceiver 1510, the COT-SI 1516 from a network access node for a COT initiated by the network access node on an unlicensed carrier. The COT-SI indicates COT resources that may be shared between at least downlink communication and sidelink communication. In some examples, the COT resources may further be shared with uplink communication. In some examples, the COT-SI 1516 may be received within DCI (e.g., DCI 2_0). The communication and processing circuitry 1542 may further store the COT-SI 1516 within, for example, memory 1505 for subsequent processing.

The communication and processing circuitry 1542 may further be configured to receive, via the transceiver 1510, a message including the COT sharing indicator 1518 indicating whether COT sidelink sharing is enabled or disabled from the network access node. For example, the message may include an RRC message or DCI (e.g., DCI 2_0). The communication and processing circuitry 1542 may further store the COT sharing indicator 1518 within, for example, memory 1505 for subsequent processing.

The communication and processing circuitry 1542 may further be configured to receive, via the transceiver 1510, DCI (e.g., DC 3_0) including sidelink resource information (e.g., identifying one or more sidelink resource pools) from the network access node. The DCI 3_0 may further include a channel access cyclic prefix (CP) extension channel access priority class (ChannelAccess-CPext-CAPC) field. The ChannelAccess-CPext-CAPC field can include the CA-CPext information 1520, which may be stored, for example, in memory 1505. The CA-CPext information 1520 indicates a listen-before-talk (LBT) type, a CP extension length, and a channel access priority class (CAPC) for COT sidelink sharing. In some examples, the communication and processing circuitry 1542 may further be configured to receive a configuration (e.g., via RRC signaling) of allowed combinations of the LBT type, the CP extension length, and the CAPC. In this example, the CA-CPext information 1520 in the ChannelAccess-CPext-CAPC field indicates one of the allowed combinations. In some examples, the CP extension length includes one of zero, a first variable multiplied by a symbol length minus 25 microseconds, a second variable multiplied by the symbol length minus 16 microseconds, or a third variable multiplied by the symbol length plus a timing advance minus 25 microseconds. In this example, there are two new CP extension lengths configured for COT sidelink sharing, namely, the second variable multiplied by the symbol length minus 16 microseconds, and the third variable multiplied by the symbol length plus a timing advance minus 25 microseconds.

The communication and processing circuitry 1542 may further be configured to receive, via the transceiver 1510, at least one of a sidelink maximum energy detection threshold (Max SL EDT) 1522 or a sidelink energy detection threshold offset (SL EDT Offset) 1524 from the network access node. The communication and processing circuitry 1542 may further be configured to store the Max SL EDT 1522 and SL EDT offset 1524 within, for example, memory 1505. The communication and processing circuitry 1542 may further be configured to receive, via the transceiver 1510, an indication of an absence of any other technology in sidelink from the network access node. The communication and processing circuitry 1542 may further be configured to execute communication and processing instructions (software) 1552 stored in the computer-readable medium 1506 to implement one or more of the functions described herein.

The processor 1504 may further include COT sharing circuitry 1544, configured to share a network access node-initiated COT with uplink and/or sidelink communication. For example, the COT sharing circuitry 1544 may be configured to perform a channel access procedure for a sidelink transmission within the COT resources based on the COT-SI 1516. In some examples, the COT sharing circuitry 1544 may be configured to perform the channel access procedure for the sidelink transmission within the COT resources in response to the COT sharing indicator 1518 indicating that COT sidelink sharing is enabled. In some examples, the COT sharing circuitry 1544 may be configured to select between a first channel access procedure type for the sidelink transmission outside the COT resources and a second channel access procedure type associated with the COT-SI for the sidelink transmission within the COT resources in response to receiving the COT-SI 1516. In some examples, the second channel access procedure type corresponds to a Type 2A channel access procedure. In some examples, the first channel access procedure type corresponds to a Type 1 channel access procedure. In some examples, the COT sharing circuitry 1544 may utilize the CA-CPext information 1520 to perform the channel access procedure within the COT resources. In some examples, the CP extension length may include one of the two new CP extension lengths configured for COT sidelink sharing.

The COT sharing circuitry 1544 may further be configured to determine an energy detection threshold (EDT) for the channel access procedure within the COT resources. In some examples, the COT sharing circuitry 1544 may be configured to set the EDT to the Max SL EDT 1522 in examples in which the Max SL EDT is received from the network access node. In examples in which the Max SL EDT is not received, but the Max UL EDT 1522 is received from the network access node, the COT sharing circuitry 1544 may then set the EDT to the Max UL EDT. In examples in which neither the Max SL EDT 1522 or the Max UL EDT 1522 is received from the network access node, the COT sharing circuitry 1544 may determine whether the network access node provided the SL EDT Offset 1524. If so, the COT sharing circuitry 1544 may adjust a default EDT 1526 by the SL EDT Offset 1524 to produce the EDT for the channel access procedure.

In some examples, the COT sharing circuitry 1544 may determine the default EDT 1526 based on either a single channel LBT bandwidth (e.g., 20 MHZ) or a maximum energy detection threshold defined for the unlicensed carrier by a regulatory requirement in response to receiving the indication of the absence of any other technology in sidelink from the network access node. In examples in which the indication of the absence of any other technology in sidelink is not received from the network access node, the COT sharing circuitry 1544 may determine the default EDT 1526 based on the single channel LBT bandwidth, a first fixed value, a second fixed value, and the Max TP 1528 for the wireless communication device.

In other examples, the COT sharing circuitry 1544 may determine the EDT based on the Max TP 1528 for the wireless communication device and an occupied bandwidth (e.g., which may be larger than the single channel LBT bandwidth). In this example, the COT sharing circuitry 1544 may be configured to determine the actual occupied bandwidth. The COT sharing circuitry 1544 may further be configured to execute COT sharing instructions (software) 1554 stored in the computer-readable medium 1506 to implement one or more of the functions described herein.

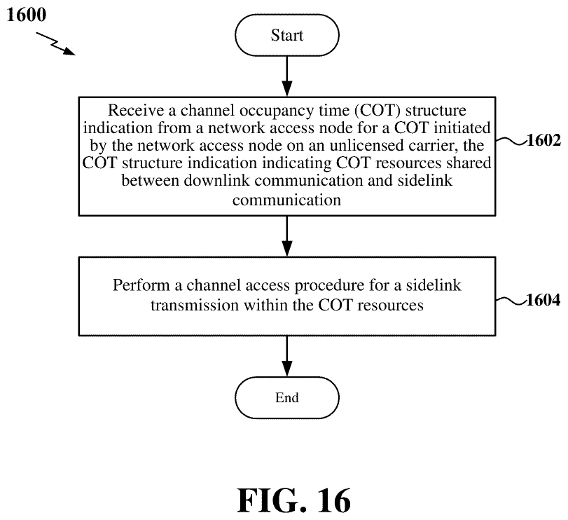

FIG. 16 is a flow chart of an exemplary method 1600 for COT sharing between downlink and sidelink according to some aspects. As described below, some or all illustrated features may be omitted in a particular implementation within the scope of the present disclosure, and some illustrated features may not be required for implementation of all examples. In some examples, the method may be performed by the wireless communication device 1500, as described above and illustrated in FIG. 15, by a processor or processing system, or by any suitable means for carrying out the described functions.

At block 1602, the wireless communication device (e.g., a UE or other sidelink device) may receive a channel occupancy time (COT) structure indication from a network access node for a COT initiated by the network access node on an unlicensed carrier, the COT structure indication indicating COT resources shared between downlink communication and sidelink communication. In some examples, the wireless communication device may receive downlink control information including the COT structure indication. In some examples, the wireless communication device may further receive a message including a COT sharing indicator indicating whether COT sidelink sharing is enabled or disabled. In some examples, the message may include a radio resource control (RRC) message or downlink control information. For example, the communication and processing circuitry 1542 and transceiver 1510, shown and described above in connection with FIG. 15, may provide a means to receive a COT structure indication.

At block 1604, the wireless communication device may perform a channel access procedure for a sidelink transmission within the COT resources. In some examples, the wireless communication device may select between a first channel access procedure type for the sidelink transmission outside the COT resources and a second channel access procedure type associated with the COT structure indication for the sidelink transmission within the COT resources in response to receiving the COT structure indication. In some examples, the second channel access procedure type corresponds to a Type 2A channel access procedure. In some examples, the wireless communication device may perform the channel access procedure for the sidelink transmission within the COT resources in response to the COT sharing indicator indicating that the COT sidelink sharing is enabled.

In some examples, the wireless communication device may receive downlink control information including sidelink resource information and a channel access cyclic prefix (CP) extension channel access priority class (ChannelAccess-CPext-CAPC) field. The ChannelAccess-CPext-CAPC field indicating a listen-before-talk (LBT) type, a CP extension length, and a channel access priority class (CAPC) for COT sidelink sharing. The wireless communication device may further perform the channel access procedure based on the LBT type, the CP extension length, and the CAPC. In some examples, the wireless communication device may further receive a configuration of allowed combinations of the LBT type, the CP extension length, and the CAPC. In this example, the ChannelAccess-CPext-CAPC field indicates one of the allowed combinations. In some examples, the CP extension length includes one of zero, a first variable multiplied by a symbol length minus 25 microseconds, a second variable multiplied by the symbol length minus 16 microseconds, or a third variable multiplied by the symbol length plus a timing advance minus 25 microseconds.

In some examples, the wireless communication device may further determine an energy detection threshold for the channel access procedure. In some examples, the wireless communication device may receive a sidelink maximum energy detection threshold. In this example, the wireless communication device may set the energy detection threshold to the sidelink maximum energy detection threshold. In some examples, the wireless communication device may receive a sidelink energy detection threshold offset. In this example, the wireless communication device may adjust a default energy detection threshold by the sidelink energy detection threshold offset to produce the energy detection threshold. In some examples, the wireless communication device may determine the default energy detection threshold based on either a single channel LBT bandwidth or a maximum energy detection threshold defined for the unlicensed carrier by a regulatory requirement. In this example, the wireless communication device may further receive an indication of an absence of any other technology in sidelink on the unlicensed carrier. In some examples, the wireless communication device may determine the default energy detection threshold based on the single channel LBT bandwidth, a first fixed value, a second fixed value, and a maximum configured transmit power in sidelink for the wireless communication device. In some examples, the wireless communication device may determine the energy detection threshold based on a maximum configured transmit power in sidelink for the wireless communication device and an occupied bandwidth. For example, the COT sharing circuitry 1544, together with the communication and processing circuitry 1542 and transceiver 1510, shown and described above in connection with FIG. 15 may provide a means to perform the channel access procedure.

In one configuration, the wireless communication device 1500 includes means for receiving a channel occupancy time (COT) structure indication from a network access node for a COT of an unlicensed carrier initiated by the network access node, the COT structure indication indicating COT resources shared between downlink communication and sidelink communication and means for performing a channel access procedure for a sidelink transmission within the COT resources, as described in the present disclosure. In one aspect, the aforementioned means may be the processor 1504 shown in FIG. 15 configured to perform the functions recited by the aforementioned means. In another aspect, the aforementioned means may be a circuit or any apparatus configured to perform the functions recited by the aforementioned means.

Of course, in the above examples, the circuitry included in the processor 1504 is merely provided as an example, and other means for carrying out the described functions may be included within various aspects of the present disclosure, including but not limited to the instructions stored in the computer-readable storage medium 1506, or any other suitable apparatus or means described in any one of the FIGS. 1, 3, 7, 8A, and/or 10A, and utilizing, for example, the processes and/or algorithms described herein in relation to FIGS. 11, 12, and/or 16.

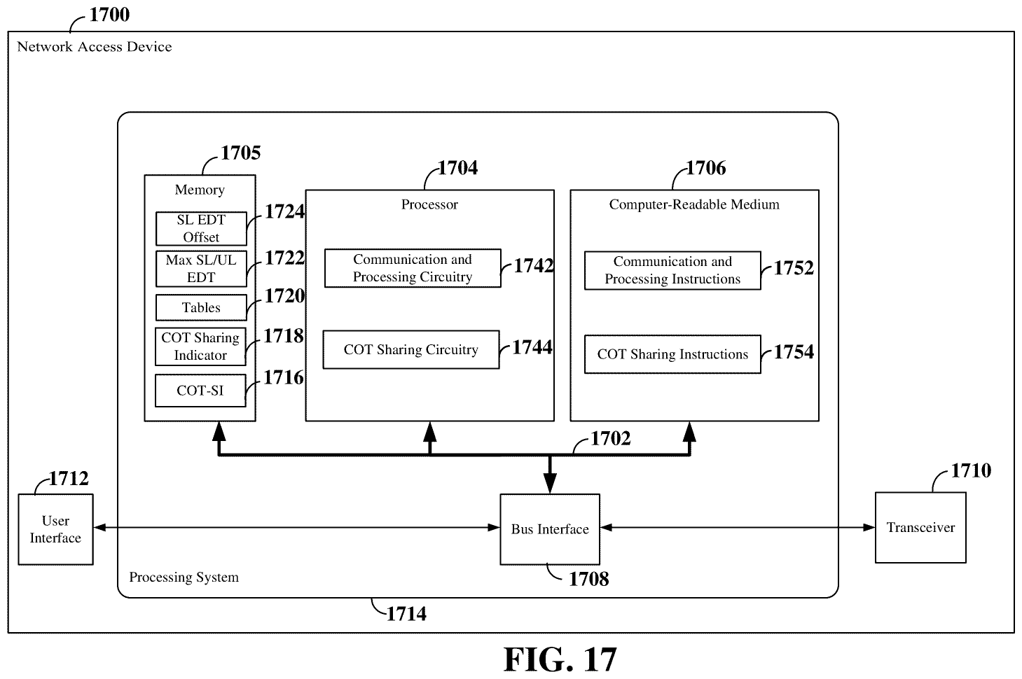

FIG. 17 is a conceptual diagram illustrating an example of a hardware implementation for an exemplary network access node 1700 employing a processing system 1714. For example, the network access node 1700 may correspond to any of the base stations (e.g., gNBs) or scheduling entities shown in any one or more of FIGS. 1, 3, 7, 8A, and/or 10A.

In accordance with various aspects of the disclosure, an element, or any portion of an element, or any combination of elements may be implemented with a processing system 1714 that includes one or more processors 1704. The processing system 1714 may be substantially the same as the processing system 1514 illustrated in FIG. 15, including a bus interface 1708, a bus 1702, memory 1705, a processor 1704, and a computer-readable medium 1706. Furthermore, the network access node 1700 may include an optional user interface 1712 and a transceiver 1710. The processor 1704, as utilized in a network access node 1700, may be used to implement any one or more of the processes described below.

In some examples, the memory 1705 may store a channel occupancy time (COT) structure indication (COT-SI) 1716, a COT sharing indicator 1718, one or more tables 1720 including, for example, LBT types, cyclic prefix (CP) extension lengths, and channel access priority classes (CAPCs), a sidelink and/or uplink maximum energy detection threshold (EDT) (Max SL/UL EDT) 1722, and a sidelink EDT offset 1724, which may be used by the processor 1704 in COT sidelink sharing. In some examples, the CP extension table 1720 includes the following CP extension lengths: zero, a first variable multiplied by a symbol length minus 25 microseconds, a second variable multiplied by the symbol length minus 16 microseconds, or a third variable multiplied by the symbol length plus a timing advance minus 25 microseconds, with the last two CP extension lengths being new CP extension lengths configured for COT sidelink sharing.

The processor 1704 may include communication and processing circuitry 1742 configured to communicate with one or more wireless communication devices via respective Uu links. In some examples, the communication and processing circuitry 1742 may include one or more hardware components that provide the physical structure that performs processes related to wireless communication (e.g., signal reception and/or signal transmission) and signal processing (e.g., processing a received signal and/or processing a signal for transmission). For example, the communication and processing circuitry 1742 may include one or more transmit/receive chains.

In some implementations where the communication involves receiving information, the communication and processing circuitry 1742 may obtain information from a component of the network access node 1700 (e.g., from the transceiver 1710 that receives the information via radio frequency signaling or some other type of signaling suitable for the applicable communication medium), process (e.g., decode) the information, and output the processed information. For example, the communication and processing circuitry 1742 may output the information to another component of the processor 1704, to the memory 1705, or to the bus interface 1708. In some examples, the communication and processing circuitry 1742 may receive one or more of signals, messages, other information, or any combination thereof. In some examples, the communication and processing circuitry 1742 may receive information via one or more channels. In some examples, the communication and processing circuitry 1742 may include functionality for a means for receiving. In some examples, the communication and processing circuitry 1742 may include functionality for a means for processing, including a means for demodulating, a means for decoding, etc.

In some implementations where the communication involves sending (e.g., transmitting) information, the communication and processing circuitry 1742 may obtain information (e.g., from another component of the processor 1704, the memory 1705, or the bus interface 1708), process (e.g., modulate, encode, etc.) the information, and output the processed information. For example, the communication and processing circuitry 1742 may output the information to the transceiver 1710 (e.g., that transmits the information via radio frequency signaling or some other type of signaling suitable for the applicable communication medium). In some examples, the communication and processing circuitry 1742 may send one or more of signals, messages, other information, or any combination thereof. In some examples, the communication and processing circuitry 1742 may send information via one or more channels. In some examples, the communication and processing circuitry 1742 may include functionality for a means for sending (e.g., a means for transmitting). In some examples, the communication and processing circuitry 1742 may include functionality for a means for generating, including a means for modulating, a means for encoding, etc.

The communication and processing circuitry 1742 may be configured to transmit a message to at least one wireless communication device. The message can include the COT sharing indicator 1718 indicating that COT sidelink sharing is enabled or disabled. In some examples, the message includes a radio resource control (RRC) message. In other examples, the message includes downlink control information (e.g., DCI 2_0). In addition, the communication and processing circuitry 1742 may be configured to transmit the COT-SI 1716 to the at least one wireless communication device for a COT initiated by the network access node 1700 on an unlicensed carrier. In examples in which the COT sharing indicator 1718 indicates that COT sidelink sharing is enabled, the COT-SI 1716 can indicate COT resources shared between downlink communication and sidelink communication. In some examples, the COT resources may further be shared with uplink communication. In some examples, the COT-SI 1716 may be transmitted within DCI (e.g., DCI 2_0).

The communication and processing circuitry 1742 may further be configured to transmit DCI (e.g., DCI 3_0) including sidelink resource information and a channel access cyclic prefix (CP) extension channel access priority class (ChannelAccess-CPext-CAPC) field. The ChannelAccess-CPext-CAPC field can indicate a listen-before-talk (LBT) type, a CP extension length, and a channel access priority class (CAPC) selected from the tables 1720 for COT sidelink sharing. In some examples, the communication and processing circuitry 1742 can further transmit a configuration (e.g., an RRC configuration) of allowed combinations of the LBT type, the CP extension length, and the CAPC selected from the tables 1720. In this example, the ChannelAccess-CPext-CAPC field includes one of the allowed combinations.

The communication and processing circuitry 1742 may further be configured to transmit at least one of the Max SL EDT 1722 or the SL EDT Offset 1724 to the at least one wireless communication device. In some examples, the communication and processing circuitry 1742 may further transmit the Max UL EDT 1722 to the at least one wireless communication device. The communication and processing circuitry 1742 may further be configured to execute communication and processing instructions (software) 1752 stored in the computer-readable medium 1706 to implement one or more of the functions described herein.

The processor 1704 may further include COT sharing circuitry 1744, configured to initiate a COT and to generate the COT-SI 1716 for sharing of the COT with uplink and/or sidelink communication. The COT sharing circuitry 1744 may further be configured to generate the COT sharing indicator 1718 to indicate whether the COT can be shared with sidelink. The COT sharing circuitry 1744 may further be configured to determine the allowed combinations of LBT type, CP extension length, and CAPC from the tables 1720. In addition, the COT sharing circuitry 1744 may be configured to select one of the allowed combinations of LBT type, CP extension length, and CAPC for inclusion in the ChannelAccess-CPext-CAPC field to be sent in DCI 3_0 to a wireless communication device. Furthermore, the COT sharing circuitry 1744 may be configured to select the Max SL/UL EDT 1722 and SL EDT Offset 1724. The COT sharing circuitry 1744 may further be configured to execute COT sharing instructions (software) 1754 stored in the computer-readable medium 1706 to implement one or more of the functions described herein.

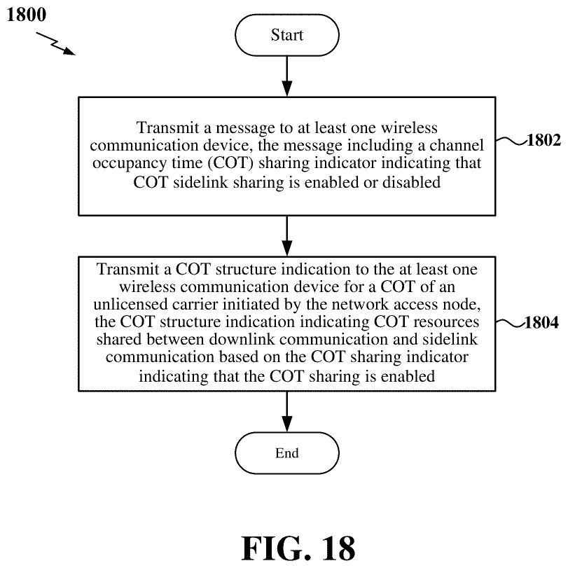

FIG. 18 is a flow chart of an exemplary method 1800 for COT sharing between downlink and sidelink according to some aspects. As described below, some or all illustrated features may be omitted in a particular implementation within the scope of the present disclosure, and some illustrated features may not be required for implementation of all examples. In some examples, the method may be performed by the network access node 1700, as described above and illustrated in FIG. 17, by a processor or processing system, or by any suitable means for carrying out the described functions.

At block 1802, the network access node (e.g., a base station, such as a gNB) may transmit a message to at least one wireless communication device. The message includes a channel occupancy time (COT) sharing indicator indicating that COT sidelink sharing is enabled or disabled. In some examples, the message includes a radio resource control (RRC) message or downlink control information. For example, the COT sharing circuitry 1744, together with the communication and processing circuitry 1742 and transceiver 1710, shown and described above in connection with FIG. 17, may provide a means to transmit the COT sharing indicator.

At block 1804, the network access node may transmit a COT structure indication to the at least one wireless communication device for a COT initiated by the network access node on an unlicensed carrier. The COT structure indication can indicate COT resources shared between downlink communication and sidelink communication based on the COT sharing indicator indicating that the COT sidelink sharing is enabled. In some examples, the network access node may transmit downlink control information including the COT structure indication.

In some examples, the network access node can further transmit downlink control information including sidelink resource information and a channel access cyclic prefix (CP) extension channel access priority class (ChannelAccess-CPext-CAPC) field. The ChannelAccess-CPext-CAPC field indicates a listen-before-talk (LBT) type, a CP extension length, and a channel access priority class (CAPC) for COT sidelink sharing. In some examples, the network access node can further transmit a configuration of allowed combinations of the LBT type, the CP extension length, and the CAPC. The ChannelAccess-CPext-CAPC field indicates one of the allowed combinations. In some examples, the CP extension length includes one of zero, a first variable multiplied by a symbol length minus 25 microseconds, a second variable multiplied by the symbol length minus 16 microseconds, or a third variable multiplied by the symbol length plus a timing advance minus 25 microseconds. In some examples, the network access node can further transmit at least one of a sidelink maximum energy detection threshold or a sidelink energy detection threshold offset to the at least one wireless communication device. For example, the COT sharing circuitry 1744 shown and described above in connection with FIG. 17 may provide a means to transmit the COT structure indication and other COT-related information.

In one configuration, the network access node 1700 includes means for transmitting a message to at least one wireless communication device, the message comprising a channel occupancy time (COT) sharing indicator indicating that COT sidelink sharing is enabled and means for transmitting a COT structure indication to the at least one wireless communication device for a COT of an unlicensed carrier initiated by the network access node, the COT structure indication indicating COT resources shared between downlink communication and sidelink communication based on the COT sharing indicator, as described in the present disclosure. In one aspect, the aforementioned means may be the processor 1704 shown in FIG. 17 configured to perform the functions recited by the aforementioned means. In another aspect, the aforementioned means may be a circuit or any apparatus configured to perform the functions recited by the aforementioned means.

Of course, in the above examples, the circuitry included in the processor 1704 is merely provided as an example, and other means for carrying out the described functions may be included within various aspects of the present disclosure, including but not limited to the instructions stored in the computer-readable storage medium 1706, or any other suitable apparatus or means described in any one of the FIGS. 1, 3, 7, 8A, and/or 10A, and utilizing, for example, the processes and/or algorithms described herein in relation to FIG. 18.

The processes shown in FIGS. 11, 12, 16, and 18 may include additional aspects, such as any single aspect or any combination of aspects described below and/or in connection with one or more other processes described elsewhere herein.

Aspect 1: A method for wireless communication at a wireless communication device, the method comprising: receiving a channel occupancy time (COT) structure indication from a network access node for a COT initiated by the network access node on an unlicensed carrier, the COT structure indication indicating COT resources shared between downlink communication and sidelink communication; and performing a channel access procedure for a sidelink transmission within the COT resources.

Aspect 2: The method of aspect 1, wherein the performing the channel access procedure further comprises: selecting between a first channel access procedure type for the sidelink transmission outside the COT resources and a second channel access procedure type associated with the COT structure indication for the sidelink transmission within the COT resources in response to receiving the COT structure indication.

Aspect 3: The method of aspect 2, wherein the second channel access procedure type corresponds to a Type 2A channel access procedure.

Aspect 4: The method of any of aspects 1 through 3, wherein the performing the channel access procedure for the sidelink transmission further comprises: receiving a message comprising a COT sharing indicator indicating whether COT sidelink sharing is enabled or disabled; and performing the channel access procedure for the sidelink transmission within the COT resources in response to the COT sharing indicator indicating that the COT sidelink sharing is enabled.

Aspect 5: The method of aspect 4, wherein the message comprises a radio resource control (RRC) message or downlink control information.

Aspect 6: The method of any of aspects 1 through 5, wherein the receiving the COT structure indication further comprises: receiving downlink control information comprising the COT structure indication.

Aspect 7: The method of any of aspects 1 through 6, wherein the performing the channel access procedure further comprises: receiving downlink control information comprising sidelink resource information and a channel access cyclic prefix (CP) extension channel access priority class (ChannelAccess-CPext-CAPC) field, the ChannelAccess-CPext-CAPC field indicating a listen-before-talk (LBT) type, a CP extension length, and a channel access priority class (CAPC) for COT sidelink sharing; and performing the channel access procedure based on the LBT type, the CP extension length, and the CAPC.

Aspect 8: The method of aspect 7, further comprising: receiving a configuration of allowed combinations of the LBT type, the CP extension length, and the CAPC, the ChannelAccess-CPext-CAPC field indicating one of the allowed combinations.

Aspect 9: The method of aspect 7 or 8, wherein the CP extension length comprises one of zero, a first variable multiplied by a symbol length minus 25 microseconds, a second variable multiplied by the symbol length minus 16 microseconds, or a third variable multiplied by the symbol length plus a timing advance minus 25 microseconds.

Aspect 10: The method of any of aspects 1 through 9, further comprising: determining an energy detection threshold for the channel access procedure.

Aspect 11: The method of aspect 10, wherein the determining the energy detection threshold further comprises: receiving a sidelink maximum energy detection threshold; and setting the energy detection threshold to the sidelink maximum energy detection threshold.

Aspect 12: The method aspect 10, wherein the determining the energy detection threshold further comprises: receiving a sidelink energy detection threshold offset; and adjusting a default energy detection threshold by the sidelink energy detection threshold offset to produce the energy detection threshold.

Aspect 13: The method of aspect 12, further comprising: determining the default energy detection threshold based on either a single channel LBT bandwidth or a maximum energy detection threshold defined for the unlicensed carrier by a regulatory requirement.

Aspect 14: The method of aspect 13, further comprising: receiving an indication of an absence of any other technology in sidelink on the unlicensed carrier.

Aspect 15: The method of aspect 13, wherein the determining the default energy detection threshold further comprises: determining the default energy detection threshold based on the single channel LBT bandwidth, a first fixed value, a second fixed value, and a maximum configured transmit power in sidelink for the wireless communication device.

Aspect 16: The method of aspect 10, wherein the determining the energy detection threshold further comprises: determining the energy detection threshold based on a maximum configured transmit power in sidelink for the wireless communication device and an occupied bandwidth.

Aspect 17: A wireless communication device comprising a transceiver, a memory, and a processor coupled to the transceiver and the memory, the processor and the memory configured to perform a method of any one of aspects 1 through 16.

Aspect 18: A wireless communication device comprising means for performing a method of any one of aspects 1 through 16.

Aspect 19: An article of manufacture comprising a non-transitory computer-readable medium having stored therein instructions executable by one or more processors of a wireless communication device to perform a method of any one of examples 1 through 16.

Aspect 20: A method for wireless communication at a network access node, the method comprising: transmitting a message to at least one wireless communication device, the message comprising a channel occupancy time (COT) sharing indicator indicating that COT sidelink sharing is enabled or disabled; and transmitting a COT structure indication to the at least one wireless communication device for a COT initiated by the network access node on an unlicensed carrier, the COT structure indication indicating COT resources shared between downlink communication and sidelink communication based on the COT sharing enabled indicator indicating that the COT sidelink sharing is enabled.

Aspect 21: The method of aspect 20, wherein the message comprises a radio resource control (RRC) message or downlink control information.

Aspect 22: The method of aspect 20 or 21, wherein the transmitting the COT structure indication further comprises: transmitting downlink control information comprising the COT structure indication.

Aspect 23: The method of any of aspects 20 through 22, further comprising: transmitting downlink control information comprising sidelink resource information and a channel access cyclic prefix (CP) extension channel access priority class (ChannelAccess-CPext-CAPC) field, the ChannelAccess-CPext-CAPC field indicating a listen-before-talk (LBT) type, a CP extension length, and a channel access priority class (CAPC) for COT sidelink sharing.

Aspect 24: The method aspect 23, further comprising: transmitting a configuration of allowed combinations of the LBT type, the CP extension length, and the CAPC, the ChannelAccess-CPext-CAPC field indicating one of the allowed combinations.

Aspect 25: The method of aspect 23 or 24, wherein the CP extension length comprises one of zero, a first variable multiplied by a symbol length minus 25 microseconds, a second variable multiplied by the symbol length minus 16 microseconds, or a third variable multiplied by the symbol length plus a timing advance minus 25 microseconds.

Aspect 26: The method of any of aspects 20 through 25, further comprising: transmitting at least one of a sidelink maximum energy detection threshold or a sidelink energy detection threshold offset to the at least one wireless communication device.

Aspect 27: A network access node comprising a transceiver, a memory, and a processor coupled to the transceiver and the memory, the processor and the memory configured to perform a method of any one of aspects 20 through 26.

Aspect 28: A network access node comprising means for performing a method of any one of aspects 20 through 26.

Aspect 19: An article of manufacture comprising a non-transitory computer-readable medium having stored therein instructions executable by one or more processors of a network access node to perform a method of any one of examples 20 through 26.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-18 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1, 3, 7, 8A, 10A, 15 and/or 17 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A wireless communication device configured for wireless communication, comprising:
a transceiver;
a memory; and
a processor coupled to the transceiver and the memory, the processor and the memory configured to:
receive a channel occupancy time (COT) structure indication via the transceiver from a network access node for a COT initiated by the network access node on an unlicensed carrier, the COT structure indication indicating COT resources shared between downlink communication and sidelink communication; and
perform a channel access procedure for a sidelink transmission within the COT resources.

2. The wireless communication device of claim 1, wherein the processor and the memory are further configured to:
select between a first channel access procedure type for the sidelink transmission outside the COT resources and a second channel access procedure type associated with the COT structure indication for the sidelink transmission within the COT resources in response to receiving the COT structure indication.

3. The wireless communication device of claim 2, wherein the second channel access procedure type corresponds to a Type 2A channel access procedure.

4. The wireless communication device of claim 1, wherein the processor and the memory are further configured to:
receive a message comprising a COT sharing indicator indicating whether COT sidelink sharing is enabled or disabled; and
perform the channel access procedure for the sidelink transmission within the COT resources in response to the COT sharing indicator indicating that the COT sidelink sharing is enabled.

5. The wireless communication device of claim 4, wherein the message comprises a radio resource control (RRC) message or downlink control information.

6. The wireless communication device of claim 1, wherein the processor and the memory are further configured to:
receive downlink control information comprising the COT structure indication.

7. The wireless communication device of claim 1, wherein the processor and the memory are further configured to:
receive downlink control information comprising sidelink resource information and a channel access cyclic prefix (CP) extension channel access priority class (ChannelAccess-CPext-CAPC) field, the ChannelAccess-CPext-CAPC field indicating a listen-before-talk (LBT) type, a CP extension length, and a channel access priority class (CAPC) for COT sidelink sharing; and
perform the channel access procedure based on the LBT type, the CP extension length, and the CAPC.

8. The wireless communication device of claim 7, wherein the processor and the memory are further configured to:
receive a configuration of allowed combinations of the LBT type, the CP extension length, and the CAPC, the ChannelAccess-CPext-CAPC field indicating one of the allowed combinations.

9. The wireless communication device of claim 7, wherein the CP extension length comprises one of zero, a first variable multiplied by a symbol length minus 25 microseconds, a second variable multiplied by the symbol length minus 16 microseconds, or a third variable multiplied by the symbol length plus a timing advance minus 25 microseconds.

10. The wireless communication device of claim 1, wherein the processor and the memory are further configured to:
determine an energy detection threshold for the channel access procedure.

11. The wireless communication device of claim 10, wherein the processor and the memory are further configured to:
receive a sidelink maximum energy detection threshold; and
set the energy detection threshold to the sidelink maximum energy detection threshold.

12. The wireless communication device of claim 10, wherein the processor and the memory are further configured to:
receive a sidelink energy detection threshold offset; and
adjust a default energy detection threshold by the sidelink energy detection threshold offset to produce the energy detection threshold.

13. The wireless communication device of claim 12, wherein the processor and the memory are further configured to:
determine the default energy detection threshold based on either a single channel LBT bandwidth or a maximum energy detection threshold defined for the unlicensed carrier by a regulatory requirement.

14. The wireless communication device of claim 13, wherein the processor and the memory are further configured to:
receive an indication of an absence of any other technology in sidelink on the unlicensed carrier.

15. The wireless communication device of claim 13, wherein the processor and the memory are further configured to:
determine the default energy detection threshold based on the single channel LBT bandwidth, a first fixed value, a second fixed value, and a maximum configured transmit power in sidelink for the wireless communication device.

16. The wireless communication device of claim 10, wherein the processor and the memory are further configured to:
determine the energy detection threshold based on a maximum configured transmit power in sidelink for the wireless communication device and an occupied bandwidth.

17. A method of wireless communication at a wireless communication device, comprising:
receiving a channel occupancy time (COT) structure indication from a network access node for a COT initiated by the network access node on an unlicensed carrier, the COT structure indication indicating COT resources shared between downlink communication and sidelink communication; and
performing a channel access procedure for a sidelink transmission within the COT resources.

18. The method of claim 17, wherein the performing the channel access procedure further comprises:
selecting between a first channel access procedure type for the sidelink transmission outside the COT resources and a second channel access procedure type associated with the COT structure indication for the sidelink transmission within the COT resources in response to receiving the COT structure indication.

19. The method of claim 17, wherein the performing the channel access procedure for the sidelink transmission further comprises:
receiving a message comprising a COT sharing indicator indicating whether COT sidelink sharing is enabled or disabled; and
performing the channel access procedure for the sidelink transmission within the COT resources in response to the COT sharing indicator indicating that the COT sidelink sharing is enabled.

20. The method of claim 17, further comprising:
receiving downlink control information comprising sidelink resource information and a channel access cyclic prefix (CP) extension channel access priority class (ChannelAccess-CPext-CAPC) field, the ChannelAccess-CPext-CAPC field indicating a listen-before-talk (LBT) type, a CP extension length, and a channel access priority class (CAPC) for COT sidelink sharing; and
receiving a configuration of allowed combinations of the LBT type, the CP extension length, and the CAPC, the ChannelAccess-CPext-CAPC field indicating one of the allowed combinations.

21. The method of claim 17, further comprising:
receiving at least one of a sidelink maximum energy detection threshold or a sidelink energy detection threshold offset;
setting an energy detection threshold to the sidelink maximum energy detection threshold in response to receiving the sidelink maximum energy detection threshold; and
adjusting a default energy detection threshold by the sidelink energy detection threshold offset in response to receiving the sidelink energy detection threshold offset without the sidelink maximum energy detection threshold.

22. A network access node configured for wireless communication, comprising:
a transceiver;
a memory; and
a processor coupled to the transceiver and the memory, the processor and the memory configured to:
transmit a message to at least one wireless communication device via the transceiver, the message comprising a channel occupancy time (COT) sharing indicator indicating that COT sidelink sharing is enabled or disabled; and
transmit a COT structure indication via the transceiver to the at least one wireless communication device for a COT initiated by the network access node on an unlicensed carrier, the COT structure indication indicating COT resources shared between downlink communication and sidelink communication based on the COT sharing indicator indicating that the COT sidelink sharing is enabled.

23. The network access node of claim 22, wherein the message comprises a radio resource control (RRC) message or downlink control information.

24. The network access node of claim 22, wherein the processor and the memory are further configured to:
transmit downlink control information comprising the COT structure indication.

25. The network access node of claim 22, wherein the processor and the memory are further configured to:
transmit downlink control information comprising sidelink resource information and a channel access cyclic prefix (CP) extension channel access priority class (ChannelAccess-CPext-CAPC) field, the ChannelAccess-CPext-CAPC field indicating a listen-before-talk (LBT) type, a CP extension length, and a channel access priority class (CAPC) for the COT sidelink sharing.

26. The network access node of claim 25, wherein the processor and the memory are further configured to:
transmit a configuration of allowed combinations of the LBT type, the CP extension length, and the CAPC, the ChannelAccess-CPext-CAPC field indicating one of the allowed combinations.

27. The network access node of claim 25, wherein the CP extension length comprises one of zero, a first variable multiplied by a symbol length minus 25 microseconds, a second variable multiplied by the symbol length minus 16 microseconds, or a third variable multiplied by the symbol length plus a timing advance minus 25 microseconds.

28. The network access node of claim 22, wherein the processor and the memory are further configured to:
transmit at least one of a sidelink maximum energy detection threshold or a sidelink energy detection threshold offset to the at least one wireless communication device.

29. A method for wireless communication at a network access node, the method comprising:
transmitting a message to at least one wireless communication device, the message comprising a channel occupancy time (COT) sharing indicator indicating that COT sidelink sharing is enabled or disabled; and
transmitting a COT structure indication to the at least one wireless communication device for a COT initiated by the network access node on an unlicensed carrier, the COT structure indication indicating COT resources shared between downlink communication and sidelink communication based on the COT sharing indicator indicating that the COT sidelink sharing is enabled.

30. The method of claim 29, further comprising:
transmitting downlink control information comprising sidelink resource information and a channel access cyclic prefix (CP) extension channel access priority class (ChannelAccess-CPext-CAPC) field, the ChannelAccess-CPext-CAPC field indicating a listen-before-talk (LBT) type, a CP extension length, and a channel access priority class (CAPC) for the COT sidelink sharing.
